(19) United States
(12) Patent Application Publication
(10) Pub. No.: US 2025/0384228 A1
(43) Pub. Date: Dec. 18, 2025

(54) DEVICE FOR TRANSLATING USING GESTURE, OPERATING METHOD THEREOF, AND STORAGE MEDIUM

(71) Applicant: Samsung Electronics Co., Ltd., Suwon-si (KR)

(72) Inventors: Hyeonseong KIM, Suwon-si (KR); Lockhee KANG, Suwon-si (KR); Jeongmin PARK, Suwon-si (KR); Sanghyun LEE, Suwon-si (KR); Hayoung JEONG, Suwon-si (KR); Seongmin JE, Suwon-si (KR)

(21) Appl. No.: 19/220,990

(22) Filed: May 28, 2025

Related U.S. Application Data
(63) Continuation of application No. PCT/KR2025/006328, filed on May 12, 2025.

(30) Foreign Application Priority Data
Jun. 18, 2024 (KR) 10-2024-0079074
Aug. 2, 2024 (KR) 10-2024-0102989

(51) Int. Cl. G06F 40/58; G06F 3/01; G06F 3/16; G06F 40/166

(52) U.S. Cl. CPC G06F 40/58; G06F 3/017; G06F 3/165; G06F 40/166

(57) ABSTRACT

A method of translating using a gesture is provided. The method includes obtaining sensor data, determining a gesture of the electronic device and a state of the electronic device through the sensor data, when a gesture for requesting a translation is detected, identifying whether a screen direction of the electronic device is oriented to a user direction or a partner direction through the state of the electronic device, obtaining whether pre-obtained voice data exists, when the pre-obtained voice data exists, translating the pre-obtained voice data into a language of a user or a language of a partner based on the screen direction of the electronic device, and outputting translated text.

### CROSS-REFERENCE TO RELATED APPLICATION(S)

This application is a continuation application, claiming priority under 35U.S.C. § 365 (c), of an International application No. PCT/KR2025/006328, filed on May 12, 2025, which is based on and claims the benefit of a Korean patent application number 10-2024-0079074, filed on Jun. 18, 2024, in the Korean Intellectual Property Office, and of a Korean patent application number 10-2024-0102989, filed on Aug. 2, 2024, in the Korean Intellectual Property Office, the disclosure of each of which is incorporated by reference herein in its entirety.

### BACKGROUND

### 1. Field

The disclosure relates to a device for translating using a gesture, an operating method thereof, and a storage medium.

### 2. Description of Related Art

In the contemporary society, with the rapid globalization, communication between people using various languages may become more important. To satisfy the demand, translation and interpretation techniques have been rapidly developed and the demand for real-time translation and interpretation services through a mobile device have increased. A smartwatch is one of the mobile devices and is a device for providing various functions to the user on the wrist.

The smartwatch includes a small display, a microphone, a speaker, and various sensors worn on the wrist, and thereby, is easily accessible regardless of locations and time. Through this, the smartwatch is used for various purposes, such as health care, exercise tracking, and receiving notifications, and is developed to provide translation and interpretation functions.

The above information is presented as background information only to assist with the understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device for translating using a gesture, an operating method thereof, and a storage medium.

Additional aspects will be set forth in part in the description which follows and, in part, will be apparent from the description, or may be learned by practice of the presented embodiments.

In accordance with an aspect of the disclosure, a method of translating using a gesture is provided. The method includes obtaining sensor data, determining a gesture of an electronic device and a state of the electronic device through the sensor data, when a gesture for requesting a translation is detected, identifying whether a screen direction of the electronic device is oriented to a user direction or a partner direction through the state of the electronic device, obtaining whether pre-obtained voice data exists, when the pre-obtained voice data exists, translating the pre-obtained voice data into a language of a user or a language of a partner based on the screen direction of the electronic device, and outputting translated text.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include obtaining sensor data, determining a gesture of an electronic device and a state of the electronic device through the sensor data, when a gesture for requesting a translation is detected, identifying whether a screen direction of the electronic device is oriented to a user direction or a partner direction through the state of the electronic device, obtaining whether pre-obtained voice data exists, when the pre-obtained voice data exists, translating the pre-obtained voice data into a language of a user or a language of a partner based on the screen direction of the electronic device, and outputting translated text.

In accordance with another aspect of the disclosure, an electronic device is provided. The electronic device includes an inertial sensor configured to measure inertial sensor data, one or more microphones configured to receive a voice, memory storing one or more computer programs, and one or more processors communicatively coupled to the inertial sensor, the one or more microphones, and the memory, wherein the one or more computer programs include computer-executable instructions that, when executed by the one or more processors individually or collectively, cause the electronic device to obtain sensor data, determine a gesture of an electronic device and a state of the electronic device through the sensor data, when a gesture for requesting a translation is detected, identify whether a screen direction of the electronic device is oriented to a user direction or a partner direction through the state of the electronic device, obtain whether pre-obtained voice data exists, when the pre-obtained voice data exists, translate the pre-obtained voice data into a language of a user or a language of a partner based on the screen direction of the electronic device, and output translated text.

In accordance with another aspect of the disclosure, a method of translating using a gesture is provided. The method includes obtaining sensor data of the wearable device, determining a gesture of the wearable device and a state of the wearable device through the sensor data of the wearable device, when a gesture for requesting a translation is detected by the wearable device, identifying whether a screen direction of the wearable device is oriented to a user direction or a partner direction through the state of the wearable device, identifying whether pre-obtained voice data exists in the wearable device, when the pre-obtained voice data exists in the wearable device, transmitting the pre-obtained voice data to a mobile device to translate the pre-obtained voice data into a language of a user or a language of a partner based on the screen direction of the wearable device, translating the pre-obtained voice data transmitted from the wearable device into the language of the user or the language of the partner in the mobile device, and outputting translated text by the mobile device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a configuration of an electronic device, according to an embodiment of the disclosure;

FIG. 2 is a diagram illustrating an operation of a processor of an electronic device according to an embodiment of the disclosure;

FIG. 3 is a diagram illustrating an operation of translating voice by a processor of an electronic device according to an embodiment of the disclosure;

FIG. 4 is a flowchart illustrating an operation of performing translation according to a gesture and a screen direction in an electronic device according to an embodiment of the disclosure;

FIG. 5 is a flowchart illustrating an operation of performing translation according to a gesture and a screen direction in an electronic device according to an embodiment of the disclosure;

FIG. 6 is a flowchart illustrating an operation of identifying a screen direction of an electronic device according to an embodiment of the disclosure;

FIG. 7 is a flowchart illustrating an operation of detecting an utterance of a speaker by an electronic device according to an embodiment of the disclosure;

FIG. 8 is a flowchart illustrating an operation of translating a voice signal by an electronic device according to an embodiment of the disclosure;

FIG. 9 is a diagram illustrating an example of determining a user direction and a partner direction based on a measured value by a sensor in an electronic device according to an embodiment of the disclosure;

FIG. 10 is a diagram illustrating an example of providing a translation of a voice of a user into a language of a partner according to an embodiment of the disclosure;

FIG. 11 is a diagram illustrating an example of providing a translation of a voice of a partner into a language of a user according to an embodiment of the disclosure;

FIG. 12 is a diagram illustrating an example of outputting a screen in a readable direction for a person viewing the screen based on a screen direction according to an embodiment of the disclosure;

FIG. 13 is a diagram illustrating an operation of adjusting a font size based on a distance between an electronic device and a partner according to an embodiment of the disclosure;

FIG. 14 is a diagram illustrating an example of sliding and outputting letters based on a distance between an electronic device and a partner according to an embodiment of the disclosure;

FIG. 15 is a diagram illustrating an example of receiving a voice of a user when a partner is adjacent to the user according to an embodiment of the disclosure;

FIG. 16 is a diagram illustrating an example of providing a translation of a voice of a user into a language of a partner when the partner is adjacent to the user according to an embodiment of the disclosure;

FIG. 17 is a block diagram illustrating a schematic structure of an electronic device according to an embodiment of the disclosure;

FIG. 18 is a block diagram of an electronic device in a network environment according to an embodiment of the disclosure;

FIG. 19 is a front perspective view of an electronic device according to an embodiment of the disclosure;

FIG. 20 is a rear perspective view of an electronic device according to an embodiment of the disclosure;

FIG. 21 is an exploded perspective view of an electronic device according to an embodiment of the disclosure;

FIG. 22 is a diagram illustrating an example of a combination for providing a translation service in association with a mobile device and a wearable device that detects a gesture according to an embodiment of the disclosure;

FIG. 23 is a diagram illustrating an example of outputting a translation result according to an embodiment of the disclosure; and

FIG. 24 is a diagram illustrating an example of requesting a translation in a case of a smart ring according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terminology used herein is for the purpose of describing particular examples only and is not to be limiting of the examples. As used herein, the singular forms “a,” “ an,” and “the” are intended to include the plural forms as well, unless the context clearly indicates otherwise. It should be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the disclosure.

Also, in the description of the components, terms such as first, second, A, B, (a), (b) or the like may be used herein when describing components of the disclosure. These terms are used only for the purpose of discriminating one constituent element from another constituent element, and the nature, the sequences, or the orders of the constituent elements are not limited by the terms. It should be noted that if one component is described as being “connected,” “coupled” or “joined” to another component, the former may be directly “connected,” “coupled,” and “joined” to the latter or “connected,” “coupled,” and “joined” to the latter via another component.

The same name may be used to describe an element included in the embodiments described above and an element having a common function. Unless otherwise mentioned, the description of one embodiment may be applicable to other embodiments. Thus, duplicated description is omitted for conciseness.

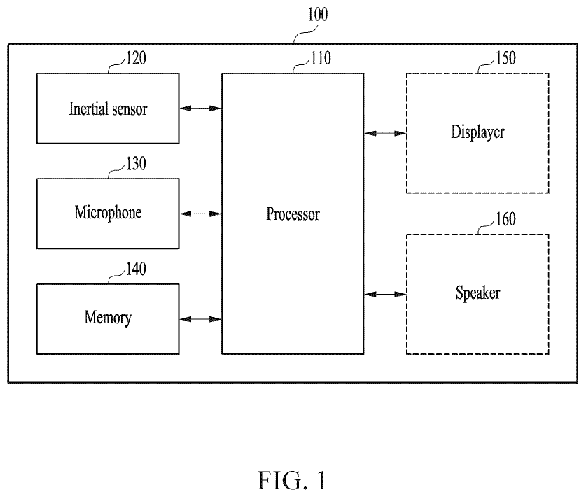

Hereinafter, a translation device using a gesture, an operating method thereof, and a storage medium according to an embodiment of the disclosure are described with reference to FIGS. 1 to 21.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 is a diagram illustrating a configuration of an electronic device, according to an embodiment of the disclosure.

Referring to FIG. 1, an electronic device 100 may include a processor 110, an inertial sensor 120, a microphone 130, memory 140, a display 150, and a speaker 160.

The inertial sensor 120 may include an acceleration sensor and a gyro sensor and may obtain sensor data including three-axis acceleration data and three-axis gyro data.

The microphone 130 may receive a voice of a user or a voice of a partner. In this case, the microphone 130 may be configured as a plurality of microphones.

The memory 140 may store a variety of data used by at least one component of the electronic device 100. The variety of data may include, for example, software and input data or output data for instructions related thereto. The memory 140 may include volatile memory or non-volatile memory.

The display 150 may visually provide information to the outside (e.g., a user) of the electronic device 100. In the disclosure, the display 150 may output translated text.

The speaker 160 may output a sound signal to the outside of the electronic device 100. The speaker 160 may be used for general purposes, such as playing multimedia or playing a recording. In addition, in the disclosure, the speaker 160 may output a converted audio signal corresponding to translated text.

Meanwhile, the display 150 and the speaker 160 of FIG. 1 may be implemented as external devices and may be omitted.

The processor 110 may control operations of electronic devices of FIGS. 1 to 21 by executing instructions stored in the memory 140. For example, the processor 110 may correspond to a plurality of processors that collectively perform a plurality of operations by dividing the operations among the processors.

The processor 110 may determine a gesture of the electronic device 100 and a state (e.g., a posture, a direction, a position) of the electronic device 100 through the sensor data, and when a gesture for requesting a translation is detected, the processor 110 may identify whether a screen direction of the electronic device 100 is oriented to a user direction or a partner direction by the state (e.g., the posture, the direction, the position) of the electronic device 100. The processor 110 may identify whether pre-obtained voice data exists, and when the pre-obtained voice data exists, the processor 110 may translate the pre-obtained voice data into a language of the user, which is the language that the user uses, or a language of the partner, which is the language that the conversation partner uses based on the screen direction of the electronic device 100, and may control to output the translated text. In this case, the processor 110 may be configured as a plurality of processors. In addition, the pre-obtained voice data may be the user's voice or the partner's voice. In this case, the gesture for requesting a translation may replace voice activity detection (VAD) or end point detection (EPD) for detecting an end of the user's utterance. In other words, the gesture for requesting a translation may be a gesture for determining the end of the utterance.

Meanwhile, when outputting the translated text, if the translated text is the partner's language, the processor 110 may measure a distance between the electronic device 100 and the user, and if the translated text is the user's language, the processor 110 may measure a distance between the electronic device 100 and the partner, may adjust and display the size of the translated text by considering the measured distance, or may adjust and output a volume level of a converted audio signal corresponding to the translated text by considering the measured distance.

In this case, the processor 110 may measure the distance from the user or the distance from the partner by a distance detection sensor. Alternatively, the processor 110 may measure the distance from the user or the distance from the partner by time difference of arrival (TDoA) using a user's voice or a partner's voice received before through at least two microphones.

In addition, when the translated text is not output to the display 150 at once, the processor 110 may output the translated text to slide on the display 150.

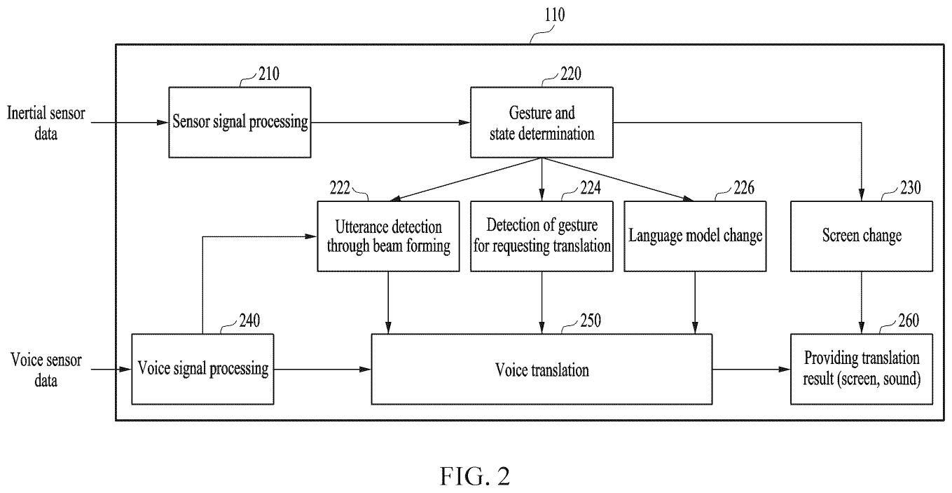

A detailed operation of the processor 110 is further described with reference to FIG. 2 below.

FIG. 2 is a diagram illustrating an operation of a processor of an electronic device according to an embodiment of the disclosure.

Referring to FIG. 2, in operation 210, the processor 110 may remove noise of sensor data by performing preprocessing on the sensor data using a filter, such as a low pass filter (LPF) or a high pass filter (HPF).

In operation 220, the processor 110 may calculate a pitch change using the preprocessed sensor data and may determine a state (e.g., a posture, a direction, a position) of the electronic device 100 by calculating a magnitude of three-axis acceleration to determine whether the electronic device 100 is stopped. In other words, the processor 110 may determine whether the electronic device 100 is oriented to a user direction or a partner direction by determining whether a range of the measured direction is included in a preset user direction or a preset partner direction using the sensor data.

In operation 222, the processor 110 may also detect an utterance of a speaker by performing beamforming using two or more microphones 130.

In operation 224, the processor 110 may identify whether a gesture for requesting a translation is detected by detecting a case in which the user stops the electronic device 100 after a specific action. In this case, the specific action may be, for example, when the electronic device 100 is a smartwatch, an action to change a direction of the screen of the electronic device 100 from the user direction to the partner direction by turning the wrist or an action to change the direction of the screen from the partner direction to the user direction by turning the wrist.

In operation 224, when the pitch change is greater than or equal to a first threshold value and the magnitude of the three-axis acceleration is less than or equal to a second threshold value, the processor 110 may determine that the gesture for requesting a translation is detected.

In operation 226, the processor 110 may change a language model according to the screen direction.

In operation 230, the processor 110 may change the screen to output translated text in a readable direction for a person viewing the screen, according to the screen direction.

In operation 240, the processor 110 may preprocess a voice signal. In this case, preprocessing may improve the quality of the voice signal by performing filter, noise removal, and frequency conversion.

In operation 250, when the gesture for requesting a translation is detected, the processor 110 may identify whether pre-obtained voice data exists, and when the pre-obtained voice data exists, the processor 110 may translate the pre-obtained voice data into the user's language or the partner's language according to the screen direction of the electronic device 100.

In operation 250, when the identified screen direction is the user direction, the processor 110 may translate pre-obtained partner's voice into the user's language. Further, when the identified screen direction is the partner direction, the processor 110 may translate a pre-obtained user's voice into the partner's language.

In operation 250, after the processor 110 controls to output the translated text, or if pre-obtained voice data does not exist, the processor 110 may receive a user's voice or a partner's voice. More specifically, when the screen direction is the user direction, the processor 110 may receive the user's voice, and when the screen direction is the partner direction, the processor 110 may receive the partner's voice.

In operation 260, the processor 110 may output the translated text.

In operation 260, the processor 110 may output the translated text through the display 150 or may convert the translated text into a voice and may output through the speaker 160. Alternatively, the processor 110 may output the translated text through the display 150 while converting the translated text into the voice and outputting through the speaker 160.

In operation 260, when outputting the translated text through the display 150, the processor 110 may output the translated text in a readable direction for a person viewing the display 150 by changing the screen in operation 230.

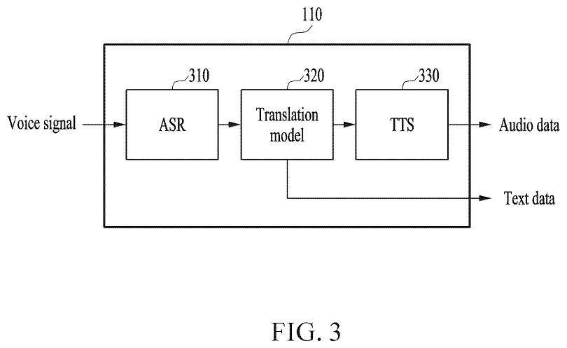

FIG. 3 is a diagram illustrating an operation of translating voice by a processor of an electronic device according to an embodiment of the disclosure.

Referring to FIG. 3, in operation 310, the processor 110 may convert a received voice signal into text by performing automatic speech recognition (ASR) on the voice signal. The processor 110 may also perform VAD for detecting an end of an utterance before processing operation 310. The VAD may also be referred to as EPD, and herein, the gesture for requesting a translation may replace the VAD.

In operation 320, the processor 110 may identify the intention of an utterance of a speaker by applying a translation model to the converted text and when the received voice signal is the partner's voice, the processor 110 may translate the converted text into the user's language and when the received voice signal is the user's voice, may translate the converted text into the partner's language and may output a translated text result. In this case, the translation model may include a large language model (LLM) and a small LLM (sLLM).

Although operations 310 and 320 are divided in FIG. 3, the ASR and the translation model may be integrated into one. A model in which the ASR and the translation model are integrated may be a speech-to-speech translation (S2ST) model.

In operation 330, the processor 110 may convert the translated text result into an audio signal by applying text-to-speech (TTS) to the translated text result.

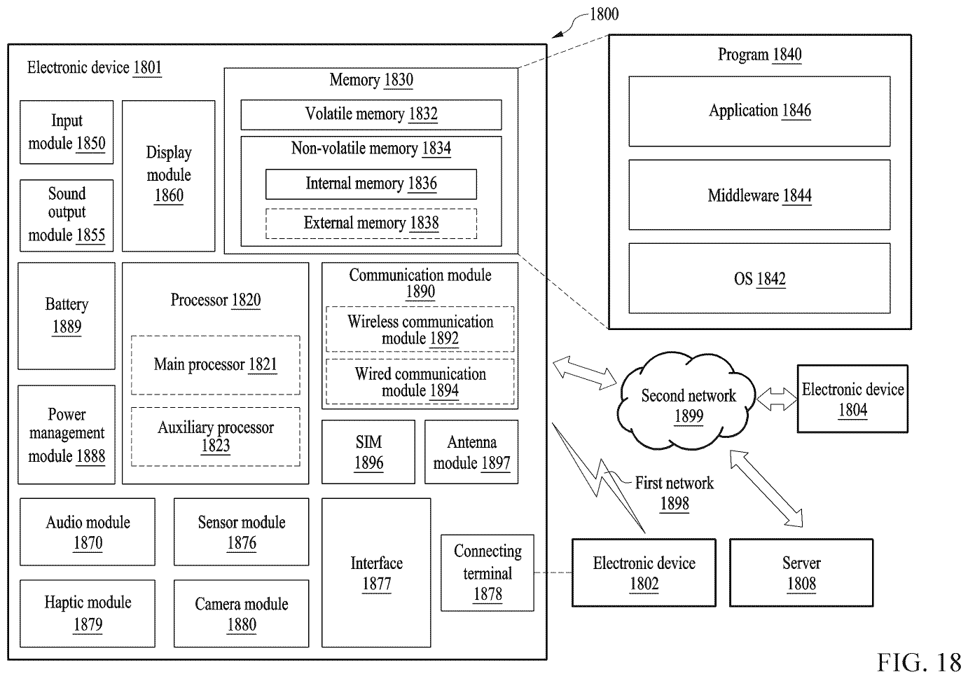

Although the disclosure describes that the execution of the LLM is an operation of the processor 110, converted text may be transmitted to an external LLM server (e.g., a server 1808 of FIG. 18) and a translated text result may be received from the LLM server (e.g., the server 1808 of FIG. 18).

The LLM may be referred to as a language model configured as an artificial neural network and pre-trained with a vast volume of text data. The LLM may include parameters (e.g., more than 100 billion parameters) more than ten times of parameters of a conventional general language model. The LLM may use a transformer artificial neural network structure based on an attention mechanism. The attention mechanism is a technology that helps an artificial intelligence model focus its attention on an important part of input data. The attention mechanism may predict to which degree at least some of time-series input data (e.g., input data, such as voice or video, or input data of several neural network layers) contributes to an intermediate or final neural network output and may be used to predict output data. A recurrent neural network (RNN) that processes each element of a sequence sequentially may show degraded prediction performance when there is information dependency between long-range time series, but the attention mechanism may use the information dependency between long-range time series by controlling weight attention in the overall (or partial) context of input data.

For example, in the LLM may include an encoder-decoder structure. An encoder may output compressed information (e.g., the attention mechanism) by processing input data, and a decoder may output output data in a token unit by processing the compressed information. Each of the encoder and the decoder may include an independent attention network and may include a cross-attention network connecting the encoder to the decoder.

For example, the LLM may be trained in two steps, pre-training and fine-tuning. The pre-training may be a process for the LLM to process a vast volume of text data and acquire general language knowledge, and may include, for example, self-supervised learning to predict a next word using a previous word sequence of a text sequence. The fine-tuning may be a process to train the LLM to be suitable for a specific domain (e.g., a chatbot, translation, summarization, Q&A) or a task and may additionally perform supervised-learning using a data set that fits the purpose of the domain based on a pre-trained model. The LLM may perform a task with a text input including natural language called prompts. For example, the LLM may include a bidirectional encoder representations from transformers (BERT) and a generative pre-trained transformer (GPT). The term “LLM” may refer to a neural network model itself but may also refer to an LLM-based application model (e.g., a chatbot, translation, summarization, text classification, or sentence generation). For example, the LLM may refer to an LLM-based chatbot, such as ChatGPT. The “LLM” may also include an inference engine using an LLM neural network model. For example, “inputting an input prompt to an LLM” may refer to “inputting the input prompt to an LLM-based inference engine.”

The sLLM may be a small-sized language model and may indicate a case in which a relatively small amount of training data is used or a model is not large. Typically, the LLM may be a model having a large number of parameters, whereas the sLLM may have a smaller number of parameters or a simple structure compared to the LLM.

Hereinafter, a method according to the disclosure configured as described above is described below with reference to the drawings.

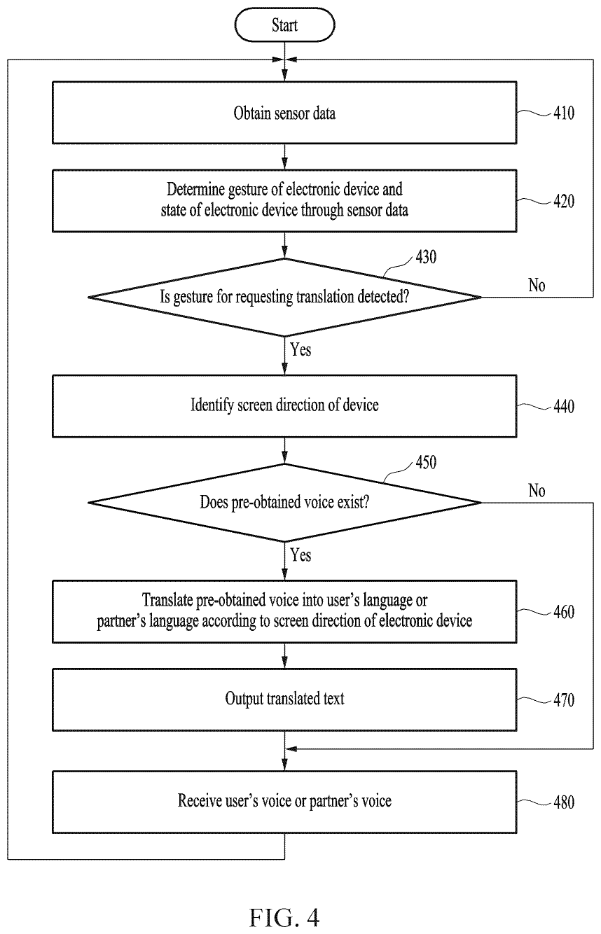

FIG. 4 is a flowchart illustrating an operation of performing translation according to a gesture and a screen direction in an electronic device according to an embodiment of the disclosure.

In the following example embodiments, operations may be performed sequentially, but not necessarily performed sequentially. For example, the order of the operations may change, and at least two of the operations may be performed in parallel.

According to an embodiment, it may be construed that operations 410 to 480 are performed by a processor (e.g., the processor 110 of FIG. 1) of an electronic device (e.g., the electronic device 100 of FIG. 1).

Referring to FIG. 4, according to an embodiment, in operation 410, the electronic device 100 may obtain sensor data. The obtained sensor data may be three-axis acceleration data and three-axis gyro data.

According to an embodiment, in operation 420, the electronic device 100 may determine a gesture of the electronic device 100 and a state (e.g., a posture, a direction, a position) of the electronic device 100 through sensor data. For example, the state of the electronic device 100 may be determined by calculating a pitch change using the sensor data and calculating a magnitude of three-axis acceleration to determine whether a motion of the electronic device 100 is stopped.

According to an embodiment, in operation 430, the electronic device 100 may identify whether a gesture for requesting a translation is detected. The gesture for requesting a translation may be the detection of a case in which the user stops the electronic device 100 after a specific action and may be a case in which the pitch change is greater than or equal to a first threshold value and the magnitude of the three-axis acceleration is less than or equal to a second threshold value.

According to an embodiment, as a result of identification in operation 430, when the gesture for requesting a translation is not detected, the electronic device 100 may return to operation 410 and may repeat a series of operations.

According to an embodiment, as a result of identification in operation 430, when the gesture for requesting a translation is detected, in operation 440, the electronic device 100 may identify whether a screen direction of the electronic device 100 is a user direction or a partner direction through the state (e.g., the posture, the direction, the position) of the electronic device 100.

According to an embodiment, in operation 450, the electronic device 100 may identify whether pre-obtained voice data exists. In this case, the pre-obtained voice data may be a voice of the user or a voice of the partner.

According to an embodiment, as a result of identification in operation 450, when the pre-obtained voice data exists, in operation 460, the electronic device 100 may translate the pre-obtained voice data into the user's language or the partner's language according to the screen direction of the electronic device 100.

More specifically, according to an embodiment, in operation 440, when the identified screen direction is the user direction, in operation 460, the electronic device 100 may translate the pre-obtained partner's voice into the user's language. In operation 440, when the identified screen direction is the partner direction, in operation 460, the electronic device 100 may translate the pre-obtained user's voice into the partner's language.

According to an embodiment, in operation 470, the electronic device 100 may output text translated in operation 460. In this case, the electronic device 100 may output the translated text to the screen or may convert the translated text into a voice and output the voice. Alternatively, the electronic device 100 may output the translated text to the screen while converting the translated text into a voice and outputting the voice.

In this case, when the electronic device 100 outputs the translated text to the screen, the electronic device 100 may output the translated text in a readable direction for a person viewing the screen. In other words, when the direction of the electronic device 100 is the partner direction, the electronic device 100 may provide the translated text to the partner by rotating the translated text 180 degrees and outputting the text so that the partner may easily read the translated text.

According to an embodiment, after outputting the translated text in operation 470 or when the pre-obtained voice data does not exist as the result of identification in operation 450, in operation 480, the electronic device 100 may receive a user's voice or a partner's voice.

More specifically, according to an embodiment, in operation 440, when the identified screen direction is the user direction, in operation 480, the electronic device 100 may receive the user's voice. When the identified screen direction is the partner direction in operation 440, in operation 480, the electronic device 100 may receive the partner's voice. When receiving the user's voice or the partner's voice in operation 480, the electronic device 100 may perform beamforming using two or more microphones, may reinforce the volume of the user's voice or the partner's voice to be greater and clearer based on the screen direction, and may minimize background noise of the reinforced voice signal. In other words, when the screen direction is oriented to the user, the electronic device 100 may remove the background noise through beamforming and may increase the clarity of the user's voice by making the user's voice louder and clearer, and when the screen direction is oriented to the partner, the electronic device 100 may remove the background noise through beamforming and may increase the clarity of the partner's voice by making the partner's voice louder and clearer. In this case, when selecting a voice to be reinforced, the electronic device 100 may select the voice according to the screen direction but may also identify a specific utterance pattern or a voice feature by a speaker detection algorithm and may detect an utterance of the speaker.

Meanwhile, when outputting the translated text in operation 470, if the translated text is the partner's language, the electronic device 100 may measure a distance from the user, and if the translated text is the user's voice, the electronic device 100 may measure a distance from the partner, may adjust and display the size of the translated text by considering the measured distance, or may adjust and output a volume level of a converted audio signal corresponding to the translated text by considering the measured distance.

In this case, the electronic device 100 may measure the distance from the user or the distance from the partner by a distance detection sensor. Alternatively, the electronic device 100 may measure the distance from the user or the distance from the partner by TDoA using the user's voice or the partner's voice received before through at least two microphones.

In addition, when the translated text is not output to the screen at once, the electronic device 100 may output the translated text to slide on the screen.

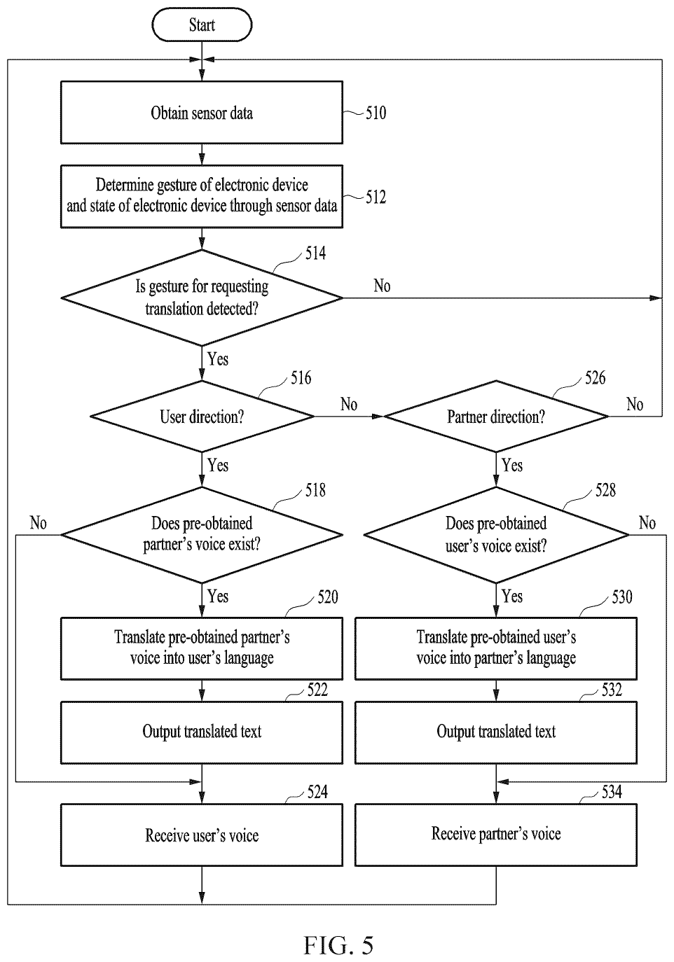

FIG. 5 is a flowchart illustrating an operation of performing translation according to a gesture and a screen direction in an electronic device according to an embodiment of the disclosure.

In the following example embodiments, operations may be performed sequentially, but not necessarily performed sequentially. For example, the order of the operations may change, and at least two of the operations may be performed in parallel.

According to an embodiment, it may be construed that operations 510 to 534 are performed by a processor (e.g., the processor 110 of FIG. 1) of an electronic device (e.g., the electronic device 100 of FIG. 1).

Referring to FIG. 5, according to an embodiment, in operation 510, the electronic device 100 may obtain sensor data. The obtained sensor data may be three-axis acceleration data and three-axis gyro data.

According to an embodiment, in operation 512, the electronic device 100 may determine a gesture of the electronic device 100 and a state (e.g., a posture, a direction, a position) of the electronic device 100 through sensor data. For example, the state (e.g., the posture, the direction, the position) of the electronic device 100 may be determined by calculating a pitch change using the sensor data and calculating a magnitude of three-axis acceleration to determine whether the electronic device 100 is stopped.

According to an embodiment, in operation 514, the electronic device 100 may identify whether a gesture for requesting a translation is detected. The gesture for requesting a translation may be the detection of a case in which the user stops the electronic device 100 after a specific action and may be a case in which the pitch change is greater than or equal to a first threshold value and the magnitude of the three-axis acceleration is less than or equal to a second threshold value.

According to an embodiment, as a result of identification in operation 514, when the gesture for requesting a translation is not detected, the electronic device 100 may return to operation 510 and may repeat a series of operations.

According to an embodiment, as a result of identification in operation 514, when the gesture for requesting a translation is detected, in operation 516, the electronic device 100 may identify whether a screen direction of the electronic device 100 is a user direction through the state (e.g., the posture, the direction, the position) of the electronic device 100.

According to an embodiment, as a result of identification in operation 516, when the identified screen direction of the electronic device 100 is the user direction, in operation 518, the electronic device 100 may identify whether pre-obtained voice data exists. In this case, the pre-obtained voice data may be the partner's voice.

According to an embodiment, when the pre-obtained voice data exists as a result of identification in operation 518, in operation 520, the electronic device 100 may translate the pre-obtained voice data into the user's language.

In addition, in operation 522, the electronic device 100 may output the text translated in operation 520. In this case, the electronic device 100 may output the translated text to the screen or may convert the translated text into a voice and output the voice. Alternatively, the electronic device 100 may output the translated text to the screen while converting the translated text into a voice and outputting the voice.

According to an embodiment, after outputting the translated text in operation 522 or when the pre-obtained voice data does not exist as the result of identification in operation 518, in operation 524, the electronic device 100 may receive a user's voice. In addition, the electronic device 100 may perform operation 524 and may return to operation 510 to repeat a series of processes.

According to an embodiment, as the result of identification in operation 516, when the screen direction of the electronic device 100 is not the user direction, in operation 526, the electronic device 100 may identify whether the screen direction is the partner direction.

According to an embodiment, as a result of identification in operation 526, when the identified screen direction of the electronic device 100 is not the partner direction, the electronic device 100 may return to operation 510 and may repeat a series of operations.

According to an embodiment, as the result of identification in operation 526, when the screen direction of the electronic device 100 is the partner direction, in operation 528, the electronic device 100 may identify whether pre-obtained voice data exists. In this case, the pre-obtained voice data may be the user's voice.

According to an embodiment, when the pre-obtained voice data exists as a result of identification in operation 528, in operation 530, the electronic device 100 may translate the pre-obtained voice data into the partner's language.

In addition, according to an embodiment, in operation 532, the electronic device 100 may output the text translated in operation 530. In this case, the electronic device 100 may output the translated text to the screen or may convert the translated text into a voice and output the voice. Alternatively, the electronic device 100 may output the translated text to the screen while converting the translated text into a voice and outputting the voice.

In this case, when outputting the translated text to the screen, the electronic device 100 may provide the translated text to the partner by rotating the translated text 180 degrees and outputting the text so that the partner may easily read the translated text.

According to an embodiment, after outputting the translated text in operation 532 or when the pre-obtained voice data does not exist as the result of identification in operation 528, in operation 534, the electronic device 100 may receive a partner's voice. In addition, the electronic device 100 may perform operation 534 and may return to operation 510 to repeat the series of processes.

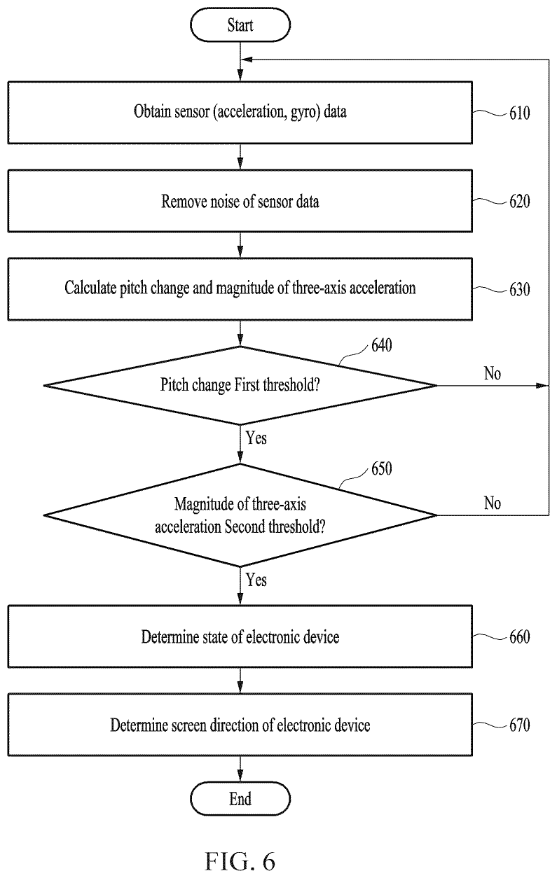

FIG. 6 is a flowchart illustrating an operation of identifying a screen direction of an electronic device according to an embodiment of the disclosure.

In the following example embodiments, operations may be performed sequentially, but not necessarily performed sequentially. For example, the order of the operations may change, and at least two of the operations may be performed in parallel.

According to an embodiment, it may be construed that operations 610 to 670 are performed by a processor (e.g., the processor 110 of FIG. 1) of an electronic device (e.g., the electronic device 100 of FIG. 1).

Referring to FIG. 6, according to an embodiment, in operation 610, the electronic device 100 may obtain sensor data. The sensor data may be three-axis acceleration data of an acceleration sensor and three-axis gyro data of a gyro sensor.

According to an embodiment, in operation 620, the electronic device 100 may remove noise of the sensor data. The electronic device 100 may remove the noise from the sensor data using a filter, such as an LPF or an HPF.

According to an embodiment, in operation 630, the electronic device 100 may calculate a pitch change and a magnitude of three-axis acceleration. In this case, the pitch change may be an amount of rotation of the electronic device 100 based on an axis connecting the 3 o'clock and 9 o'clock directions of the electronic device 100 and may be determined by a differential sum (diff sum) or dispersion during a predetermined time period.

According to an embodiment, in operation 640, the electronic device 100 may identify whether the pitch change is greater than or equal to a first threshold value.

According to an embodiment, when the pitch change is greater than or equal to the first threshold value as a result of identification in operation 640, in operation 650, the electronic device 100 may identify whether the magnitude of the three-axis acceleration is less than or equal to a second threshold value.

According to an embodiment, when the pitch change is not greater than or equal to the first threshold value as the result of identification in operation 640 or the magnitude of the three-axis acceleration is not less than or equal to the second threshold value as a result of identification in operation 650, the electronic device 100 may determine that the gesture for requesting a translation is not detected and may return to operation 610 to repeat a series of operations.

According to one embodiment, when the magnitude of the three-axis acceleration is less than or equal to the second threshold value as the result of identification in operation 650, in operation 660, the electronic device 100 may determine a state (e.g., the posture, the direction, the position) of the electronic device 100. In other words, the electronic device 100 may identify a final pitch angle of the electronic device 100 when there is no motion of the electronic device 100.

According to an embodiment, in operation 670, the electronic device 100 may determine whether the screen direction of the electronic device 100 is the user direction of the partner direction through the state determination result of operation 650.

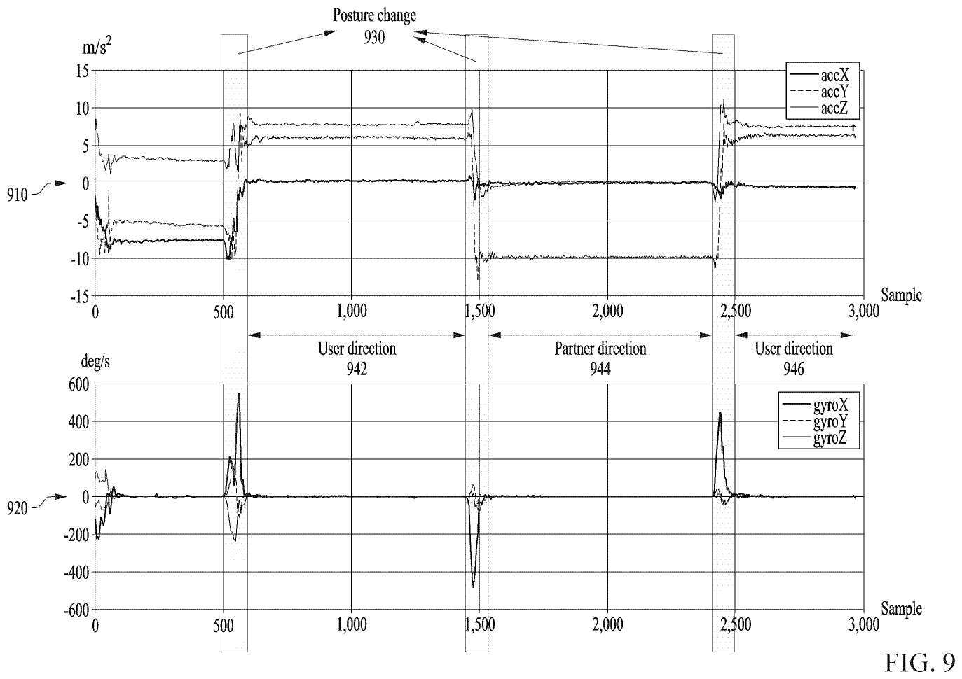

An example of determining the user direction or the partner direction using the sensor data is described below with reference to FIG. 9.

FIG. 9 is a diagram illustrating an example of determining a user direction and a partner direction based on a measured value by a sensor in an electronic device according to an embodiment of the disclosure.

Referring to FIG. 9, 910 is a graph showing a change in three-axis acceleration data as a screen direction changes when the electronic device 100 is a smartwatch. In the graph of 910, the x-axis is a sample value and the y-axis is m/s.². 920 is a graph showing a change in three-axis gyro data as the screen direction changes when the electronic device 100 is a smartwatch. In the graph of 920, the x-axis is a sample value and the y-axis is deg/s.

When examining a section 930 in which a state (e.g., a posture, a direction, a position) changes and a direction of the screen changes, the change in the three-axis acceleration data and the change in the three-axis gyro data are significantly changed.

In addition, while maintaining user directions 942, 946 and a partner direction 944, the change in the three-axis acceleration data and the change in the three-axis gyro data are not significant.

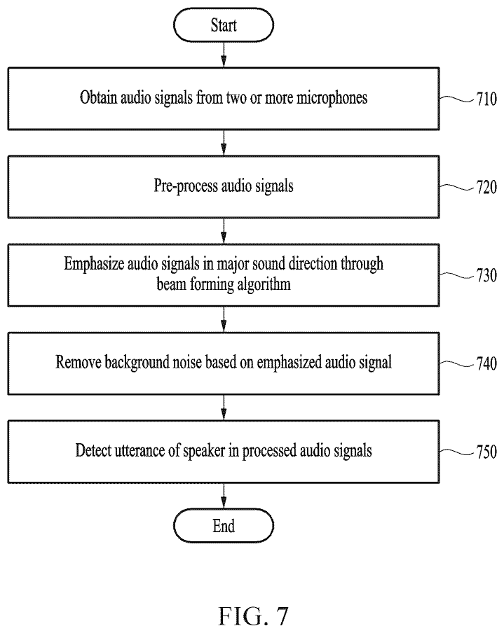

FIG. 7 is a flowchart illustrating an operation of detecting an utterance of a speaker by an electronic device according to an embodiment of the disclosure.

In the following example embodiments, operations may be performed sequentially, but not necessarily performed sequentially. For example, the order of the operations may change, and at least two of the operations may be performed in parallel.

According to an embodiment, it may be construed that operations 710 to 750 are performed by a processor (e.g., the processor 110 of FIG. 1) of an electronic device (e.g., the electronic device 100 of FIG. 1).

Referring to FIG. 7, according to an embodiment, in operation 710, the electronic device 100 may obtain an audio signal from two or more microphones. In this case, the obtained audio signal may be multi-channel.

According to an embodiment, in operation 720, the electronic device 100 may preprocess the obtained audio signal. In this case, preprocessing may improve the quality of the audio signal by performing filter, noise removal, and frequency conversion.

According to an embodiment, in operation 730, the electronic device 100 may emphasize the audio signal in a main sound direction through a beamforming algorithm. In this case, emphasizing the audio signal in the main sound direction may refer to removing background noise and making a volume of the audio signal to be louder and clearer in the main sound direction.

According to an embodiment, in operation 740, the electronic device 100 may remove background noise based on the emphasized audio signal. In other words, the electronic device 100 may emphasize an utterance in the main sound direction and may minimize the background noise.

According to an embodiment, in operation 750, the electronic device 100 may detect an utterance of a speaker in the processed audio signal. More specifically, the electronic device 100 may identify a specific utterance pattern or a voice feature in the processed audio signal through a speaker detection algorithm and may detect the utterance of the speaker.

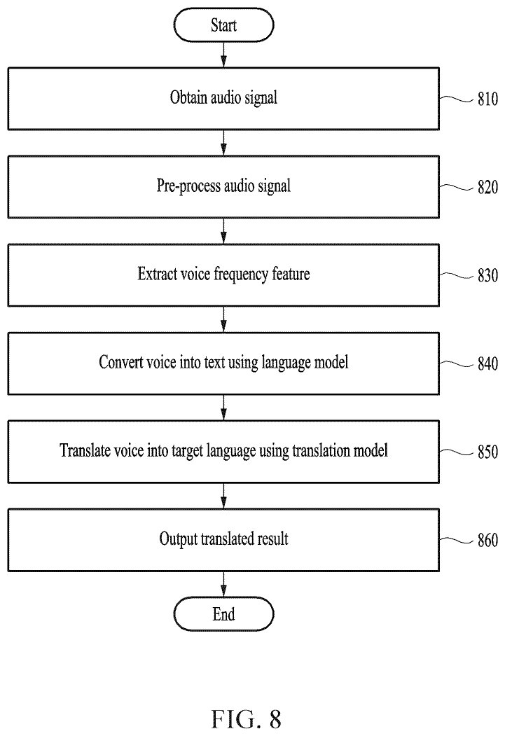

FIG. 8 is a flowchart illustrating an operation of translating a voice signal by an electronic device according to an embodiment of the disclosure.

In the following example embodiments, operations may be performed sequentially, but not necessarily performed sequentially. For example, the order of the operations may change, and at least two of the operations may be performed in parallel.

According to an embodiment, it may be construed that operations 810 to 860 are performed by a processor (e.g., the processor 110 of FIG. 1) of an electronic device (e.g., the electronic device 100 of FIG. 1).

Referring to FIG. 8, according to an embodiment, in operation 810, the electronic device 100 may obtain a voice signal. In this case, the electronic device 100 may determine a range of input audio to be used as voice data using a user's gesture for requesting a translation. For example, the electronic device 100 may determine that the gesture for requesting a translation is detected by detecting that a screen direction of the electronic device 100 is changed from the user direction to the partner direction or from the partner direction to the user direction. After detecting the gesture for requesting a translation, the electronic device 100 may not use a voice input through a microphone in operations 820 to 860 until translated text is output.

According to an embodiment, in operation 820, the electronic device 100 may preprocess the collected voice signal. In this case, the electronic device 100 may improve the quality of the voice signal by preprocessing the voice signal using at least one of noise removal, filtering, and normalization.

According to an embodiment, in operation 830, the electronic device 100 may extract a voice frequency feature. In this case, the electronic device 100 may extract a frequency feature of the voice using a frequency transformation technique, such as Fourier transform or mel-frequency cepstral coefficients (MFCC).

According to an embodiment, in operation 840, the electronic device 100 may convert the voice into text by applying a language model to the extracted frequency feature of the voice. In this case, the electronic device 100 may select and apply a language model corresponding to the voice by considering the screen direction.

According to an embodiment, in operation 850, the electronic device 100 may translate the text into a target language, which is the language to be translated, using a translation model. In this case, the electronic device 100 may translate the input text into the target language based on machine translation and a trained language pattern through the translation model. Although operations 840 and 850 are divided in FIG. 8, the language model and the translation model may be integrated into one. A model in which the language model and the translation model are integrated may be S2ST.

According to an embodiment, in operation 860, the electronic device 100 may output a translated result. In this case, the electronic device 100 may output the translated result as text or voice through the screen or the speaker.

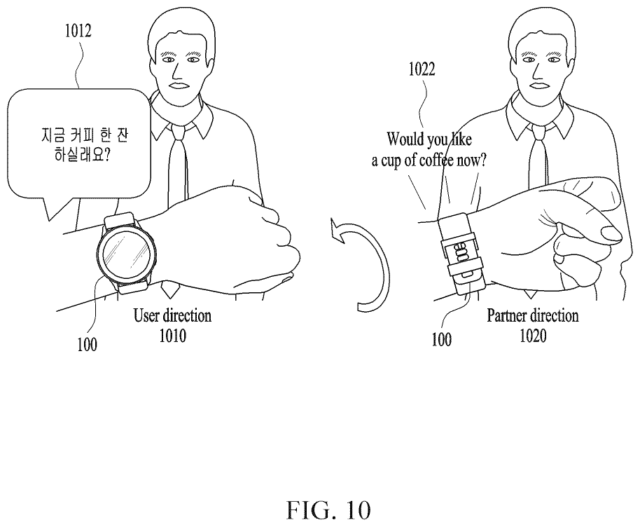

An example in which the electronic device for translating using a gesture in the disclosure is applied to a smartwatch is described below with reference to FIGS. 10 to 14.

FIG. 10 is a diagram illustrating an example of providing a translation of a voice of a user into a language of a partner according to an embodiment of the disclosure.

Referring to FIG. 10, when the electronic device 100 is a smartwatch, the electronic device 100 may receive “ [symbol] [symbol] 48 ” 1012, which is a user's voice in a user direction 1010, and when a screen direction of the electronic device 100 changes to a partner direction 1020 through a wrist-turning gesture, the electronic device 100 may output “Would you like a cup of coffee now?” 1022, which is the translation of the received user's voice into the partner's language.

In FIG. 10, when the screen direction of the electronic device 100 is the user direction 1010, the electronic device 100 may allow the user to identify whether the user's voice is correctly input by outputting the received voice of the user as text through the screen of the electronic device 100.

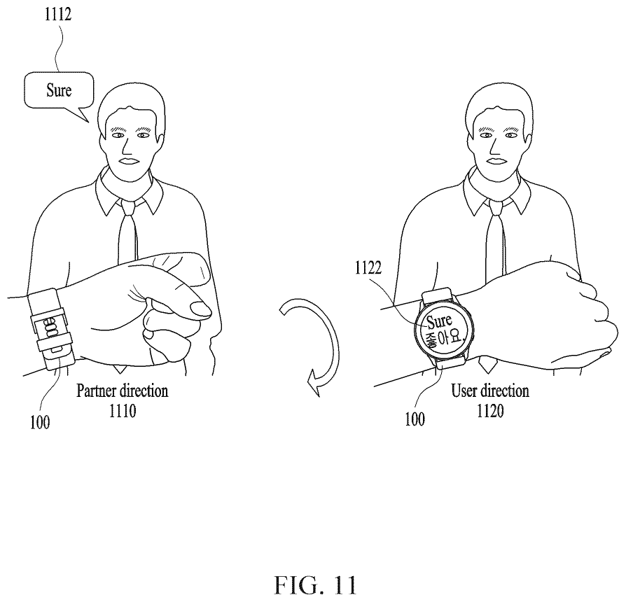

FIG. 11 is a diagram illustrating an example of providing a translation of a voice of a partner into a language of a user according to an embodiment of the disclosure.

Referring to FIG. 11, when the electronic device 100 is a smartwatch, the electronic device 100 may receive “Sure” 1112, which is a partner's voice in a partner direction 1110, and when a screen direction of the electronic device 100 changes to the user direction 1120 through a wrist-turning gesture, the electronic device 100 may output “ [symbol] ” 1122, which is the translation of the received partner's voice into the user's language.

In FIG. 11, when the screen direction of the electronic device 100 is the partner direction 1110, the electronic device 100 may allow the partner to identify whether the partner's voice is correctly input by outputting the received voice of the partner as text through the screen of the electronic device 100.

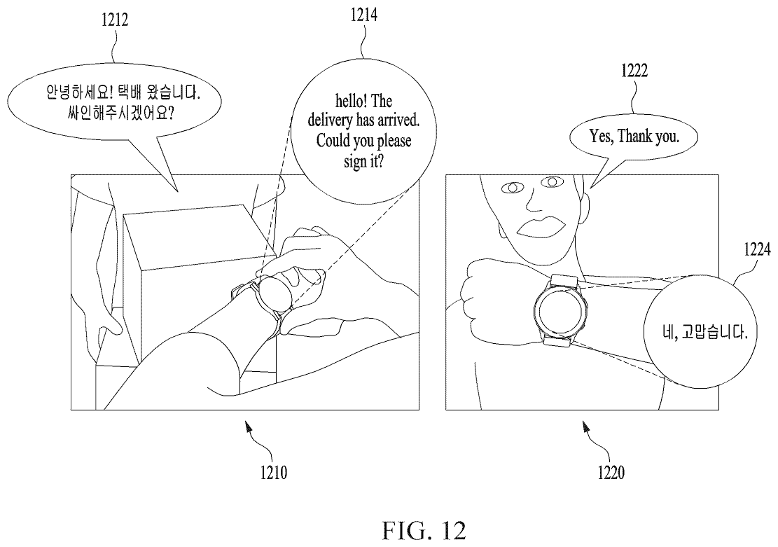

FIG. 12 is a diagram illustrating an example of outputting a screen in a readable direction for a person viewing the screen based on a screen direction according to an embodiment of the disclosure.

Referring to FIG. 12, when the electronic device 100 is a smartwatch, if a screen direction of the electronic device 100 is changed to a user direction 1210 oriented to the user, the electronic device 100 may output “Hello! The delivery has arrived. Could you please sign it?” 1214, which is a translation of the partner's voice, “ [symbol] ! [symbol] . [symbol] [symbol] ” 1212, to the screen of the electronic device 100 in a direction that the user may easily read.

In addition, when the screen direction is changed to a partner direction 1220 oriented to the partner, the electronic device 100 may output “ [symbol] .” 1224, which is a translation of the user's voice “Yes, Thank you.” 1222, to the screen of the electronic device 100 in a direction that the partner may easily read (e.g., rotating it approximately 180 degrees).

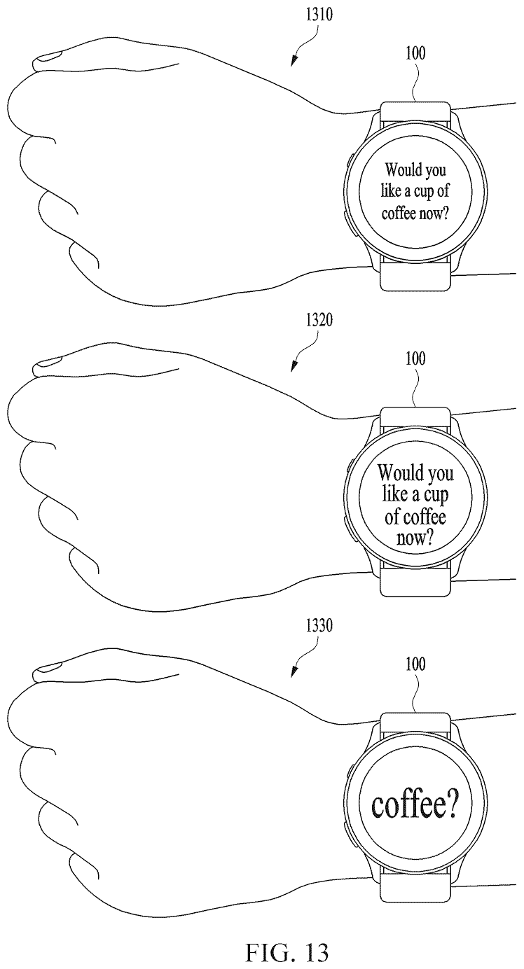

FIG. 13 is a diagram illustrating an operation of adjusting a font size based on a distance between an electronic device and a partner according to an embodiment of the disclosure.

Referring to FIG. 13, the electronic device 100 may adaptively adjust a size of translated letters shown on the screen of the electronic device 100 and a volume of the speaker based on a distance between the electronic device 100 and the partner.

In a case 1310 in which the distance between the partner and the electronic device 100 is close (e.g., approximately 30 cm), the electronic device 100 may output the letters in a size that is provided default (a preset size) (e.g., a font size 7) and may provide audio at a speaker level 3.

However, in a case 1320 in which the distance between the partner and the electronic device 100 is far (e.g., approximately 100 cm), the electronic device 100 may output letters in a preset size (e.g., a font size 12) based on the distance and may provide the audio at a speaker level 7. In addition, the electronic device 100 may make the font bold or may change the color of the font to improve readability.

In other words, the translated content may be provided to the partner with a larger font size and louder audio in the case 1320 in which the distance between the partner and the electronic device 100 is far compared to the case 1310 in which the distance is close.

When the electronic device 100 is unable to output the translated content adjusted with an increased font size to the screen at once or in a case 1330 in which the user desires to output summarized content, the electronic device 100 may summarize the translated content and may output the summarized content. For example, the electronic device 100 may summarize the translated content (Would you like a cup of coffee now?) or may extract a keyword and may output the summarized content (coffee?) or the keyword (coffee?).

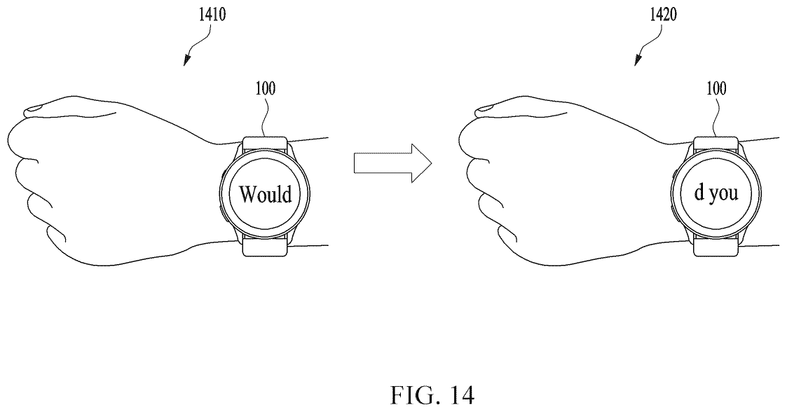

FIG. 14 is a diagram illustrating an example of sliding and outputting letters based on a distance between an electronic device and a partner according to an embodiment of the disclosure.

Referring to FIG. 14, when the translated content (Would you like a cup of coffee now?) is not output to the screen of the electronic device 100 at once as a result of increasing a font size because the distance between the partner and the electronic device 100 is far, the electronic device 100 may output the translated content to slide as shown in operation 1410 and in operation 1420.

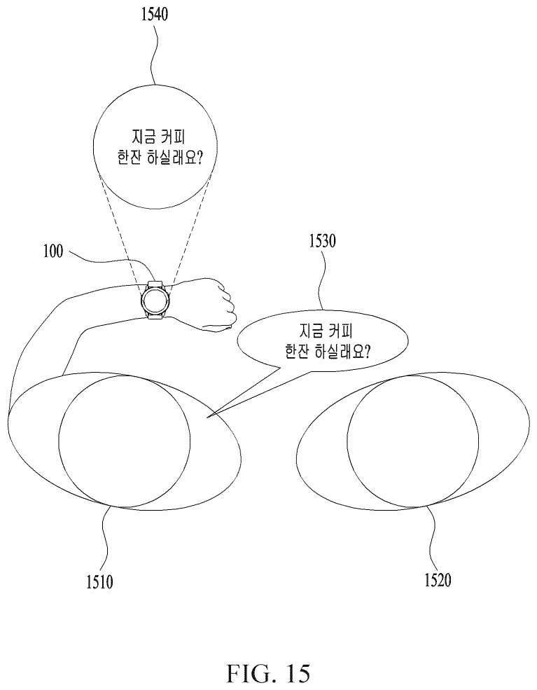

FIG. 15 is a diagram illustrating an example of receiving a voice of a user when a partner is adjacent to the user according to an embodiment of the disclosure.

Referring to FIG. 15, when the electronic device 100 is a smartwatch, if the electronic device 100 receives “ [symbol] [symbol] ?” 1530, which is a voice of a user 1510 in a direction toward the user 1510, the electronic device 100 may output “ [symbol] [symbol] ?” 1540, which is text corresponding to the received voice, to the screen of the electronic device 100. In this case, the electronic device 100 may output “ [symbol] [symbol] ?” 1540 in a direction that the user 1510 may easily read.

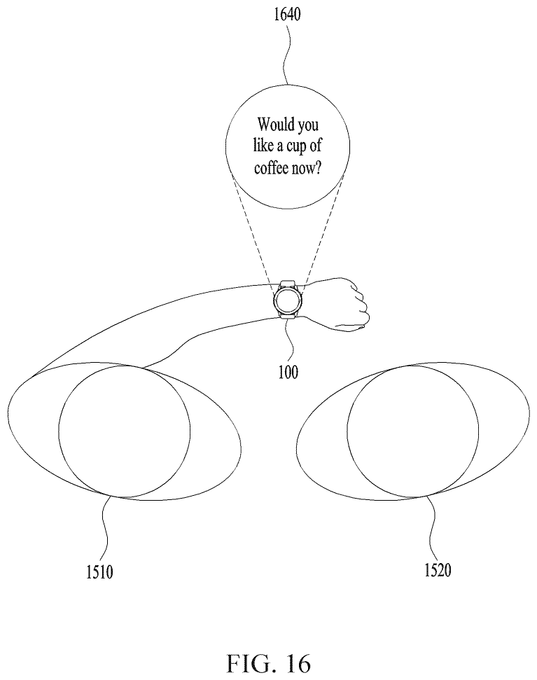

FIG. 16 is a diagram illustrating an example of providing a translation of a voice of a user into a language of a partner when the partner is adjacent to the user according to an embodiment of the disclosure.

When the electronic device 100 is a smartwatch and a screen direction of the electronic device 100 changes to a direction oriented to the user 1510 to a direction 1020 oriented to a partner 1520 through a wrist-stretching gesture, the electronic device 100 may translate “ [symbol] [symbol] ?” 1530, which is the received user's voice, into a language of the partner 1520 and may output “Would you like a cup of coffee now?” 1640. In this case, the electronic device 100 may output “Would you like a cup of coffee now?” 1640 in a direction that the partner 1520 may easily read.

Meanwhile, the electronic device 100 may detect the wrist-stretching gesture by a change in an acceleration sensor included in the inertial sensor 120.

Referring to FIGS. 15 and 16, the user 1510 and the partner 1520 may stand side by side rather than facing each other, and thereby, the directions that the user 1510 and the partner 1520 may easily read may be the same.

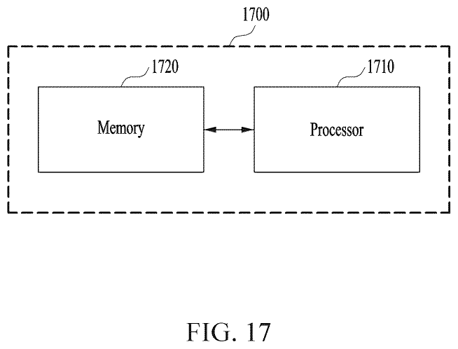

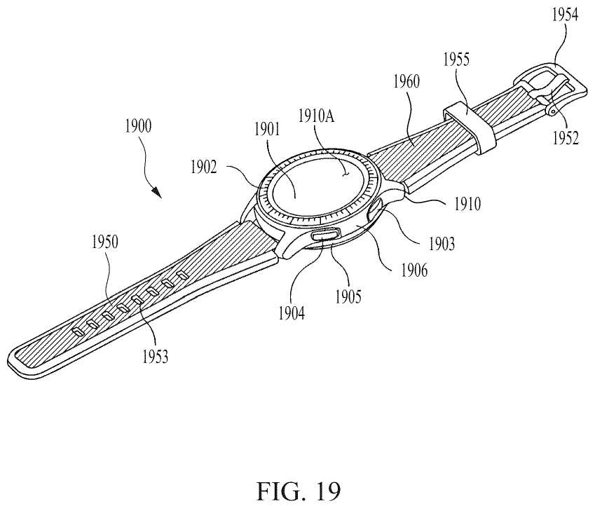

Meanwhile, the electronic device 100 of FIG. 1 may be configured as an electronic device 1700 of FIG. 17 below, an electronic device 1801 in a network environment as shown in FIG. 18, or a smartwatch as shown in FIGS. 19 to 21.

FIG. 17 is a block diagram illustrating a schematic structure of an electronic device according to an embodiment of the disclosure.

Referring to FIG. 17, an electronic device 1700 may include a processor 1710 and memory 1720.

The memory 1720 may store a variety of data used by at least one component (e.g. the processor 1710) of the electronic device 1700. The variety of data may include, for example, software and input data or output data for instructions related thereto. The memory 1720 may include volatile memory or non-volatile memory. In this case, the memory 1720 may be a component corresponding to the memory 140 of FIG. 1.

The processor 1710 may control the overall operations of the electronic device 1700. When the processor 1710 detects a gesture for requesting a translation, the processor 1710 may identify whether the screen direction of the electronic device 1700 is the user direction or the partner direction, may identify whether pre-obtained voice data exists, and when the pre-obtained voice data exists, may translate the pre-obtained voice data into the user's language or the partner's language based on the screen direction of the electronic device 1700, and may control to output the translated text. In this case, the processor 1710 may be configured as a plurality of processors. In addition, the pre-obtained voice data may be the user's voice or the partner's voice. In this case, the processor 1710 may be a component corresponding to the processor 110 of FIG. 1.

FIG. 18 is a block diagram of an electronic device in a network environment according to an embodiment of the disclosure.

Referring to FIG. 18, the electronic device 1801 in the network environment 1800 may communicate with an electronic device 1802 via a first network 1898 (e.g., a short-range wireless communication network), or communicate with an electronic device 1804 or a server 1808 via a second network 1899 (e.g., a long-range wireless communication network). According to an embodiment, the electronic device 1801 may communicate with the electronic device 1804 via the server 1808. According to an embodiment, the electronic device 1801 may include a processor 1820, memory 1830, an input module 1850, a sound output module 1855, a display module 1860, an audio module 1870, and a sensor module 1876, an interface 1877, a connecting terminal 1878, a haptic module 1879, a camera module 1880, a power management module 1888, a battery 1889, a communication module 1890, a subscriber identification module (SIM) 1896, or an antenna module 1897. In some embodiments, at least one (e.g., the connecting terminal 1878) of the above components may be omitted from the electronic device 1801, or one or more other components may be added to the electronic device 1801. In some embodiments, some (e.g., the sensor module 1876, the camera module 1880, or the antenna module 1897) of the components may be integrated as a single component (e.g., the display module 1860).

The processor 1820 may execute, for example, software (e.g., a program 1840) to control at least one other component (e.g., a hardware or software component) of the electronic device 1801 connected to the processor 1820, and may perform various data processing or computation. According to an embodiment, as at least a part of data processing or computation, the processor 1820 may store a command or data received from another component (e.g., the sensor module 1876 or the communication module 1890) in a volatile memory 1832, process the command or the data stored in the volatile memory 1832, and store resulting data in a non-volatile memory 1834. In this case, the processor 1820 may be a component corresponding to the processor 110 of FIG. 1.

According to an embodiment, the processor 1820 may include a main processor 1821 (e.g., a central processing unit (CPU) or an application processor (AP)) or an auxiliary processor 1823 (e.g., a graphics processing unit (GPU), a neural processing unit (NPU), an image signal processor (ISP), a sensor hub processor, or a communication processor (CP)) that is operable independently from, or in conjunction with the main processor 1821. For example, when the electronic device 1801 includes the main processor 1821 and the auxiliary processor 1823, the auxiliary processor 1823 may be adapted to consume less power than the main processor 1821 or to be specific to a specified function. The auxiliary processor 1823 may be implemented separately from the main processor 1821 or as a part of the main processor 1321.

The auxiliary processor 1823 may control at least some of functions or states related to at least one (e.g., the display module 1860, the sensor module 1876, or the communication module 1890) of the components of the electronic device 1801, instead of the main processor 1821 while the main processor 1821 is in an inactive (e.g., sleep) state or along with the main processor 1821 while the main processor 1821 is an active state (e.g., executing an application). According to an embodiment, the auxiliary processor 1823 (e.g., an ISP or a CP) may be implemented as a portion of another component (e.g., the camera module 1880 or the communication module 1890) that is functionally related to the auxiliary processor 1823. According to an embodiment, the auxiliary processor 1823 (e.g., an NPU) may include a hardware structure specified for artificial intelligence (AI) model processing. An AI model may be generated by machine learning. Such learning may be performed by, for example, the electronic device 1801 in which artificial intelligence is performed, or performed via a separate server (e.g., the server 1808). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 1830 may store various data used by at least one component (e.g., the processor 1820 or the sensor module 1876) of the electronic device 1801. The various pieces of data may include, for example, software (e.g., the program 1840) and input data or output data for a command related thereto. The memory 1830 may include the volatile memory 1832 or the non-volatile memory 1834. In this case, the memory 1830 may be a component corresponding to the memory 140 of FIG. 1.

The program 1840 may be stored as software in the memory 1830 and may include, for example, an operating system (OS) 1842, middleware 1844, or an application 1846.

The input module 1850 may receive a command or data to be used by another component (e.g., the processor 1820) of the electronic device 1801, from the outside (e.g., a user) of the electronic device 1801. The input module 1850 may include, for example, a microphone, a mouse, a keyboard, a key (e.g., a button), or a digital pen (e.g., a stylus pen). In this case, the input module 1850 may be a component including the microphone 130 of FIG. 1.

The sound output module 1855 may output a sound signal to the outside of the electronic device 1801. The sound output module 1855 may include, for example, a speaker or a receiver. The speaker may be used for general purposes, such as playing multimedia or playing a recording. The receiver may be used to receive an incoming call. According to one embodiment, the receiver may be implemented separately from the speaker or as a part of the speaker. In this case, the sound output module 1855 may be a component including the speaker 160 of FIG. 1.

The display module 1860 may visually provide information to the outside (e.g., a user) of the electronic device 1801. The display module 1860 may include, for example, a display, a hologram device, or a projector and control circuitry to control a corresponding one of the display, the hologram device, and the projector. According to an embodiment, the display module 1860 may include a touch sensor adapted to sense a touch, or a pressure sensor adapted to measure an intensity of a force incurred by the touch. In this case, the display module 1860 may be a component corresponding to the display 150 of FIG. 1.

The audio module 1870 may convert a sound into an electrical signal or vice versa. According to an embodiment, the audio module 1870 may obtain the sound via the input module 1850 or output the sound via the sound output module 1855 or an external electronic device (e.g., an electronic device 1802 such as a speaker or headphones) directly or wirelessly connected to the electronic device 1801.

The sensor module 1876 may detect an operational state (e.g., power or temperature) of the electronic device 1801 or an environmental state (e.g., a state of a user) external to the electronic device 1801, and generate an electrical signal or data value corresponding to the detected state. According to an embodiment, the sensor module 1876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor. In this case, the sensor module 1876 may be a component including the inertial sensor 120 of FIG. 1.

The interface 1877 may support one or more specified protocols to be used for the electronic device 1801 to be coupled with the external electronic device (e.g., the electronic device 1802) directly (e.g., by wire) or wirelessly. According to an embodiment, the interface 1877 may include, for example, a high-definition multimedia interface (HDMI), a universal serial bus (USB) interface, a secure digital (SD) card interface, or an audio interface.

The connecting terminal 1878 may include a connector via which the electronic device 1801 may be physically connected to an external electronic device (e.g., the electronic device 1802). According to an embodiment, the connecting terminal 1878 may include, for example, an HDMI connector, a USB connector, an SD card connector, or an audio connector (e.g., a headphone connector).

The haptic module 1879 may convert an electric signal into a mechanical stimulus (e.g., a vibration or a movement) or an electrical stimulus which may be recognized by a user via his or her tactile sensation or kinesthetic sensation. According to an embodiment, the haptic module 1879 may include, for example, a motor, a piezoelectric element, or an electric stimulator.

The camera module 1880 may capture a still image and moving images. According to an embodiment, the camera module 1880 may include one or more lenses, image sensors, ISPs, or flashes.

The power management module 1888 may manage power supplied to the electronic device 1801. According to an embodiment, the power management module 1888 may be implemented as, for example, at least a part of a power management integrated circuit (PMIC).

The battery 1889 may supply power to at least one component of the electronic device 1801. According to an embodiment, the battery 1889 may include, for example, a primary cell which is not rechargeable, a secondary cell which is rechargeable, or a fuel cell.

The communication module 1890 may support establishing a direct (e.g., wired) communication channel or a wireless communication channel between the electronic device 1801 and the external electronic device (e.g., the electronic device 1802, the electronic device 1804, or the server 1808) and performing communication via the established communication channel. The communication module 1890 may include one or more CPs that are operable independently from the processor 1820 (e.g., an AP) and that support a direct (e.g., wired) communication or a wireless communication. According to an embodiment, the communication module 1890 may include a wireless communication module 1892 (e.g., a cellular communication module, a short-range wireless communication module, or a global navigation satellite system (GNSS) communication module) or a wired communication module 1894 (e.g., a local area network (LAN) communication module, or a power line communication (PLC) module). A corresponding one of these communication modules may communicate with the external electronic device 1804 via the first network 1898 (e.g., a short-range communication network, such as Bluetooth™, wireless-fidelity (Wi-Fi) direct, or infrared data association (IrDA)) or the second network 1899 (e.g., a long-range communication network, such as a legacy cellular network, a fifth-generation (5G) network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 1892 may identify and authenticate the electronic device 1801 in a communication network, such as the first network 1898 or the second network 1899, using subscriber information (e.g., international mobile subscriber identity (IMSI)) stored in the SIM 1896.

The wireless communication module 1892 may support a 5G network after a fourth-generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 1892 may support a high-frequency band (e.g., a mmWave band) to achieve, e.g., a high data transmission rate. The wireless communication module 1892 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 1892 may support various requirements specified in the electronic device 1801, an external electronic device (e.g., the electronic device 1804), or a network system (e.g., the second network 1899). According to an embodiment, the wireless communication module 1892 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1897 may transmit or receive a signal or power to or from the outside (e.g., an external electronic device) of the electronic device 101. According to an embodiment, the antenna module 1897 may include an antenna including a radiating element including a conductive material or a conductive pattern formed in or on a substrate (e.g., a printed circuit board (PCB)). According to an embodiment, the antenna module 1897 may include a plurality of antennas (e.g., array antennas). In such a case, at least one antenna appropriate for a communication scheme used in a communication network, such as the first network 1898 or the second network 1899, may be selected by, for example, the communication module 1890 from the plurality of antennas. The signal or power may be transmitted or received between the communication module 1890 and the external electronic device via the at least one selected antenna. According to an embodiment, another component (e.g., a radio frequency integrated circuit (RFIC)) other than the radiating element may be additionally formed as a part of the antenna module 1897.

According to an embodiment, the antenna module 1897 may form a mm Wave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., a mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment, commands or data may be transmitted or received between the electronic device 1801 and the external electronic device 1804 via the server 1808 coupled with the second network 1899. Each of the external electronic devices 1802 and 1804 may be a device of the same type as or a different type from the electronic device 1801. According to one embodiment, all or some of operations to be executed by the electronic device 1801 may be executed at one or more external electronic devices 1802 or 1804, or server 1808. For example, if the electronic device 1801 needs to perform a function or a service automatically, or in response to a request from a user or another device, the electronic device 1801, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 1801. The electronic device 1801 may provide the result, with or without further processing the result, as at least part of a response to the request. To that end, cloud computing, distributed computing, mobile edge computing (MEC), or client-server computing technology may be used, for example. The electronic device 1801 may provide ultra low-latency services using, e.g., distributed computing or mobile edge computing. In another embodiment, the external electronic device 1804 may include an Internet-of-things (IoT) device. The server 1808 may be an intelligent server using machine learning and/or a neural network. According to an example embodiment, the external electronic device 1804 or the server 1808 may be included in the second network 1899. The electronic device 1801 may be applied to intelligent services (e.g., smart home, smart city, smart car, or healthcare) based on 5G communication technology or IoT-related technology.

FIG. 19 is a front perspective view of an electronic device according to an embodiment of the disclosure.

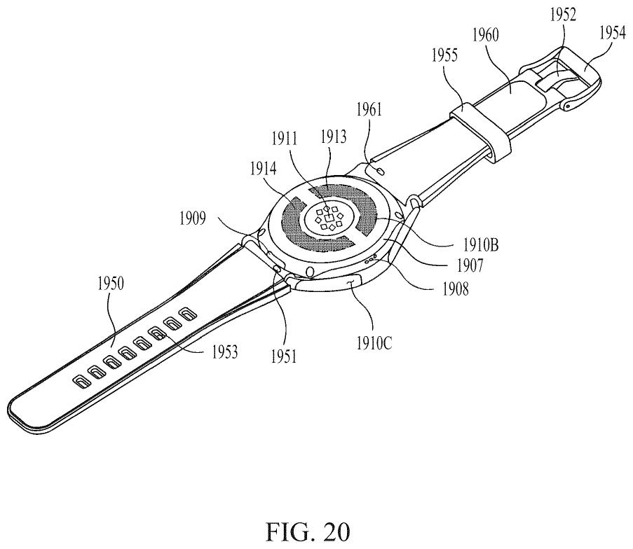

FIG. 20 is a rear perspective view of an electronic device according to an embodiment of the disclosure.

Referring to FIGS. 19 and 20, an electronic device 1900 (e.g., the electronic device 1801 of FIG. 18) according to an embodiment may include a housing 1910 including a first surface (or a front surface) 1910A, a second surface (or a rear surface) 1910B, and a side surface 1910C enclosing a space between the first surface 1910A and the second surface 1910B, and fastening members 1950 and 1960 connected to at least a portion of the housing 1910 and configured to be detachably fasten the electronic device 1900 to a body part (e.g., the wrist, ankle, etc.) of a user. In some embodiments (not shown), the housing may refer to a structure forming a portion of the first surface 1910A, the second surface 1910B, and the side surface 1910C of FIG. 19. According to an embodiment, the first surface 1910A may be formed by a front plate 1901 (e.g., a glass plate or polymer plate including various coating layers) of which at least a portion is substantially transparent. The second surface 1910B may be formed of a rear plate 1907 that is substantially opaque. The rear plate 1907 may be formed of, for example, coated or tinted glass, ceramic, polymer, metal (e.g., aluminum, stainless steel (STS), or magnesium), or any combination of any two or more of the above materials. The side surface 1910C may be coupled to the front plate 1901 and the rear plate 1907 and may be formed by a side bezel structure (or a “side member”) 1906 including metal and/or polymer. In some embodiments, the rear plate 1907 and the side bezel structure 1906 may be integrally formed and may include the same material (e.g., a metal material such as aluminum). The fastening members 1950 and 1960 may be formed of various materials and shapes. For example, woven fabric, leather, rubber, urethane, metal, ceramic, or a combination of at least two of the aforementioned materials may be formed in an integrated form or with a plurality of unit links that are movable relative to each other.

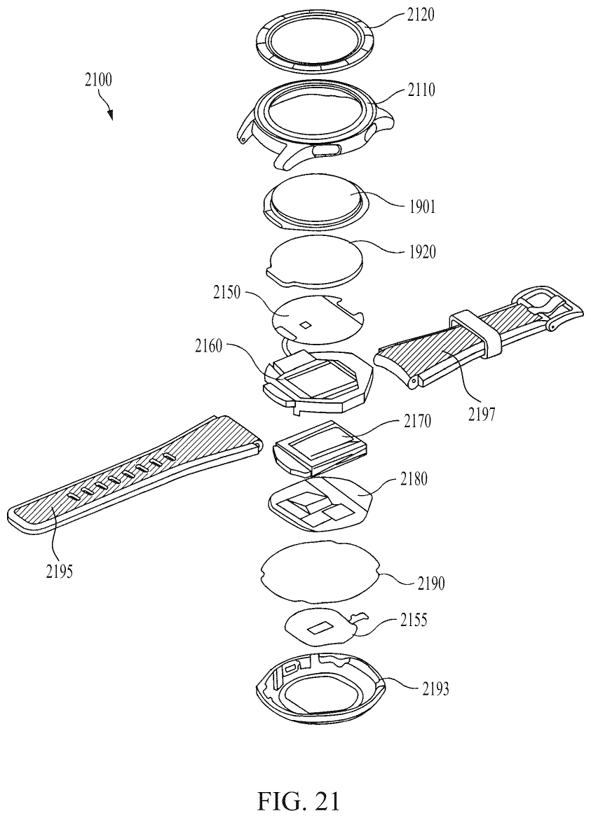

According to an embodiment, the electronic device 1900 may include at least one of a display 1920 (refer to FIG. 21), a microphone hole 1905 and a speaker hole 1908 of audio module 1870, a sensor module 1911, key input devices 1902, 1903, and 1904, and a connector hole 1909. In some example embodiments, the electronic device 1900 may not include at least one (e.g., the key input devices 1902, 1903, and 1904, the connector hole 1909, or the sensor module 1911) of the components, or may additionally include other components.

The display 1920 may be exposed through, for example, some portions of the front plate 1901. A shape of the display 1920 may be a shape corresponding to the shape of the front plate 1901, and may have various shapes, such as a circle, an oval, or a polygon. The display 1920 may be coupled to or disposed adjacent to a touch sensing circuit, a pressure sensor configured to measure an intensity (pressure) of a touch, and/or a fingerprint sensor.

The audio module 1870 may include a microphone hole 1905 and a speaker hole 1908. The microphone hole 1905 may have a microphone therein to obtain external sound, and, in some embodiments, a plurality of microphones may be disposed therein to detect a sound direction. The speaker hole 1908 may be used as an external speaker or a phone call receiver. In some embodiments, the speaker hole 1908 and the microphone hole 1905 may be integrated into one or a speaker may be included without the speaker hole 1908 (e.g., a piezo speaker).

The sensor module 1911 may generate an electrical signal or a data value corresponding to an internal operating state of the electronic device 1900 or an external environmental state. The sensor module 1911 may include, for example, a biosensor module (e.g., a heart rate monitor (HRM) sensor) disposed on the second surface 1910B of the housing 1910. The electronic device 1900 may further include at least one of sensor modules (not shown), for example, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, and an illuminance sensor.

The sensor module 1911 may include electrode areas 1913 and 1914 forming a portion of the surface of the electronic device 1900 and a biosignal detection circuit (not shown) electrically connected to the electrode areas 1913 and 1914. For example, the electrode areas 1913 and 1914 may include a first electrode area 1913 and a second electrode area 1914 that are disposed on the second surface 1910B of the housing 1910. The sensor module 1911 may be configured to cause the electrode areas 1913 and 1914 to obtain an electrical signal from a body part of the user and cause the biosignal detection circuit to detect biometric information of the user based on the electrical signal.

The key input devices 1902, 1903, and 1904 may include a wheel key 1902 disposed on the first surface 1910A of the housing 1910 and rotatable in at least one direction, and/or side key buttons 1903 and 1904 disposed on the side surface 1910C of the housing 1910. A shape of the wheel key may correspond to the shape of the front plate 1901. In an embodiment, the electronic device 1900 may not include some or all of the key input devices 1902, 1903, and 1904 described above and the key input device 1902, 1903, and 1904 that are not included may be implemented in another form such as a soft key on the display 1920. The connector hole 1909 may include a connector hole for accommodating a connector (e.g., a universal serial bus (USB) connector) configured to transmit and receive power and/or data to and from an external electronic device, and/or another connector hole (not shown) for accommodating a connector configured to transmit and receive an audio signal to and from an external electronic device. The electronic device 1900 may further include, for example, a connector cover (not shown) that covers at least a portion of the connector hole 1909 and blocks the inflow of a foreign substance into the connector hole.

The fastening members 1950 and 1960 may be detachably fastened to at least a partial area of the housing 1910 using locking members 1951 and 1961. The fastening members 1950 and 1960 may include at least one of a securing member 1952, a securing member fastening hole 1953, a band guide member 1954, and a band securing ring 1955.

The securing member 1952 may be configured to secure the housing 1910 and the fastening members 1950 and 1960 to a body part (e.g., the wrist or ankle) of the user. The securing member fastening hole 1953 may secure the housing 1910 and the fastening members 1950 and 1960 to a body part of the user in correspondence with the securing member 1952. The band guide member 1954 may be configured to restrict a movement range of the securing member 1952 when the securing member 1952 is fastened to the securing member fastening hole 1953, and thereby, the fastening members 1950 and 1960 may be fastened to a body part of the user while being in close contact with the body part. The band securing ring 1955 may restrict a movement range of the fastening members 1950 and 1960 while the securing member 1952 is fastened to the securing member fastening hole 1953.

FIG. 21 is an exploded perspective view of an electronic device according to an embodiment of the disclosure.

Referring to FIG. 21, an electronic device 2100 (e.g., the electronic device 1801 of FIG. 18 or the electronic device 1900 of FIGS. 19 and 20) may include a side bezel structure 2110, a wheel key 2120, the front plate 1901, the display 1920, a first antenna 2150, a second antenna 2155, a support member 2160 (e.g., a bracket), a battery 2170, a PCB 2180, a sealing member 2190, a rear plate 2193 (e.g., the rear plate 1907 of FIG. 19), and fastening members 2195 and 2197 (e.g., the fastening members 1950 and 1960 of FIGS. 19 and 20). At least one of the components of the electronic device 2100 may be the same as or similar to at least one of the components of the electronic device 1900 of FIG. 18, 19, or 20, and accordingly a repeated description thereof is omitted. The support member 2160 may be disposed in the electronic device 2100 and may be connected to the size bezel structure 2110 or may be integrally formed with the side bezel structure 2110 as one. The support member 2160 may be formed of, for example, a metal material and/or a non-metal (e.g., polymer) material. The display 1920 may be coupled to one surface of the support member 2160 and the PCB 2180 may be coupled to the other surface of the support member 2160. A processor, memory, and/or an interface may be mounted on the PCB 2180. The processor may include, for example, at least one of a central processing unit (CPU), an application processor (AP), a graphics processing unit (GPU), an sensor processor, or a communication processor (CP).

The memory may include, for example, a volatile memory or a non-volatile memory. The interface may include, for example, a high-definition multimedia interface (HDMI), a universal serial bus (USB) interface, a secure digital (SD) card interface, and/or an audio interface. For example, the interface may electrically or physically connect the electronic device 2100 to an external electronic device and may include a USB connector, an SD card/multimedia card (MMC) connector, or an audio connector.

The battery 2170 may be a device for supplying power to at least one component of the electronic device 2100 and may include, for example, a non-rechargeable primary battery, a rechargeable secondary battery, or a fuel cell. For example, at least a portion of the battery 2170 may be disposed on substantially the same plane as the PCB 2180. The battery 2170 may be disposed integrally inside the electronic device 1900, or disposed detachably from the electronic device 1900.

The first antenna 2150 may be disposed between the display 1920 and the support member 2160. The first antenna 2150 may include, for example, a near field communication (NFC) antenna, a wireless charging antenna, and/or a magnetic secure transmission (MST) antenna. For example, the first antenna 2150 may perform NFC with an external device, may wirelessly transmit or receive power required for charging, and may transmit an NFC signal or a magnetic-based signal including payment data. In an embodiment, an antenna structure may be formed by a portion of the side bezel structure 2110 and/or the support member 2160 or a combination thereof.

The second antenna 2155 may be disposed between the PCB 2180 and the rear plate 2193. The second antenna 2155 may include, for example, an NFC antenna, a wireless charging antenna, and/or an MST antenna. For example, the second antenna 2155 may perform NFC with an external device, may wirelessly transmit or receive power required for charging, and may transmit an NFC signal or a magnetic-based signal including payment data. In an embodiment, an antenna structure may be formed by a portion of the side bezel structure 2110 and/or the rear plate 2193 or a combination thereof.

The sealing member 2190 may be disposed between the side bezel structure 2110 and the rear plate 2193. The sealing member 2190 may be configured to block moisture and a foreign substance from entering a space surrounded by the side bezel structure 2110 and the rear plate 2193 from the outside.

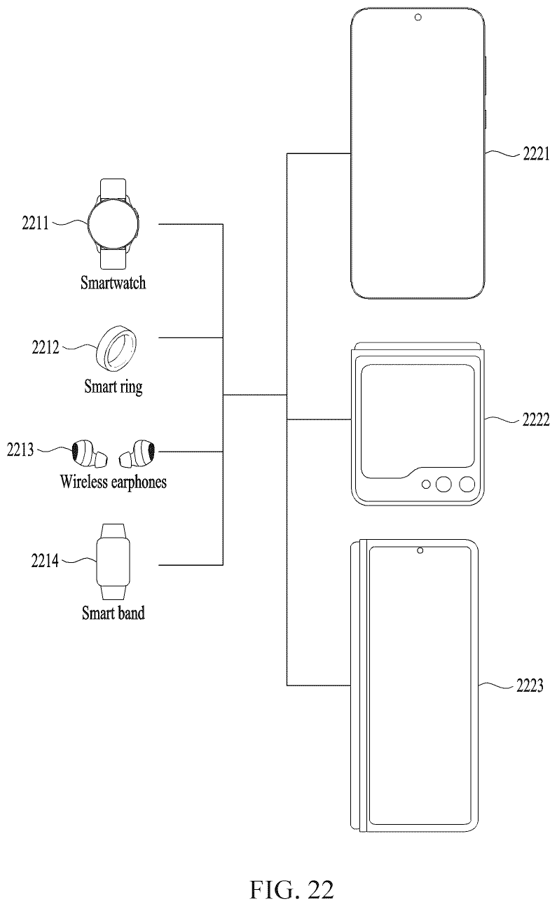

FIG. 22 is a diagram illustrating an example of a combination for providing a translation service in association with a mobile device and a wearable device that detects a gesture according to an embodiment of the disclosure.

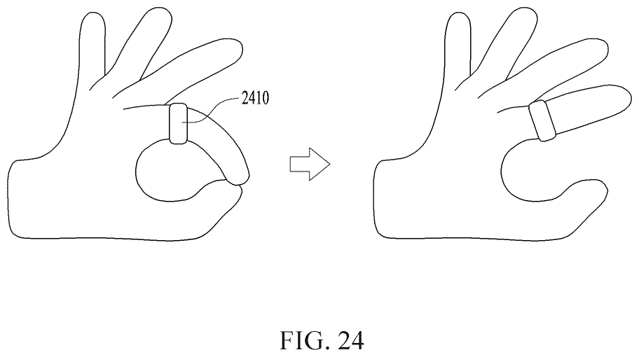

Referring to FIG. 22, the detection of a gesture for requesting a translation may be performed by various wearable devices 2211, 2212, 2213, and 2214. For example, in a smartwatch 2211 (e.g., Galaxy watch), a smart ring 2212 (e.g., Galaxy ring), or a smart band 2214 (e.g., Galaxy fit) that are worn on a wrist or a finger, a gesture to turn the device, a gesture to stretch a hand toward the partner, a double-tap gesture (the double-tap gesture is described below with reference to FIG. 24) in a hand wearing the wearable device 2211, 2212, 2213, or 2214 may set to the gesture for requesting a translation. In the case of wireless earphones 2213 (e.g., Galaxy buds), which are wearable devices worn on the ears, a gesture of nodding or turning left and right while wearing the device may be set to the gesture for requesting a translation. In the case of the smartring 2212, a gesture of tapping the ring worn on an index finger, a gesture of swiping up or down, or a gesture of snapping fingers may be set to the gesture for requesting a translation. The gestures of various wearable devices 2211, 2212, 2213, and 2214 may be detected by inertial sensors in the wearable devices 2211, 2212, 2213, and 2214. In this case, the gesture for requesting a translation may be a gesture that replaces VAD for identifying an end of an utterance.

In addition, the wearable devices 2211, 2212, 2213, and 2214 may divide a plurality of gestures by operations. For example, when displaying a translation result on a linked device, the gesture of turning the wrist of the smartwatch 2211 may be used as a gesture to change a language model and VAD and the double-tap gesture of the smartwatch 2211 may be used as a gesture for VAD. As described, when a user of the smartwatch 2211 speaks for a long time and the user performs the double-tap gesture while speaking, the utterance of the user input until the gesture may be translated, may be output to linked mobile devices 2221, 2222, and 2223, and may be shown to the partner, and when the user performs a gesture of turning the smartwatch 2211, the utterance of the user until the gesture may be translated, a translation result may be output, and the translation model may be changed to translate the utterance of the partner. In the case of the smart ring 2212, the gesture of swiping up or down the smart ring 2212 worn on the index finger may perform VAD and language model change and the gesture of tapping the smart ring 2212 may perform VAD only.

The wearable devices 2211, 2213, and 2214 including microphones may receive utterances of the user and the partner, may translate the utterances, and may output translation results by transmitting the translation results to the linked mobile devices 2221, 2222, and 2223. In addition, the wearable devices 2211, 2213, and 2214 including microphones may receive a voice input, and the translation may be performed by the linked mobile devices 2221, 2222, and 2223. For example, the smartwatch 2211 may receive a voice input of the user or partner and when a gesture is performed, a text result or audio data through ASR, and information about the language model may be transmitted to the linked devices 2221, 2222, and 2223, the linked mobile devices 2221, 2222, and 2223 may translate the received text result or audio data using a language model corresponding thereto, and the translation result may be output to the linked mobile devices 2221, 2222, and 2223.

In the case of the wearable device 2212 without a microphone or a case (e.g., the wireless earphones 2213) in which it is difficult to receive an utterance of the partner, the user's utterance or the partner's utterance may be received through the linked mobile devices 2221, 2222, and 2223, and the wearable device 2212 without a microphone may be used for VAD.

In the case of wireless earphones 2213, the user and the partner may share the earphones and wear one each. In this case, each of the right wireless earphone and the left wireless earphone may receive a user's voice or a partner's voice wearing the earphones and when a gesture is detected, a text result or audio data through ASR may be transmitted to the linked devices 2221, 2222, and 2223. The linked mobile devices 2221, 2222, and 2223 may translate the received text result or audio data using a language model corresponding thereto, may output a translation result to the screens of the mobile devices 2221, 2222, and 2223, and may output the translation result as audio to the user or the partner through the right wireless earphone or the left wireless earphone worn by the user or the partner.

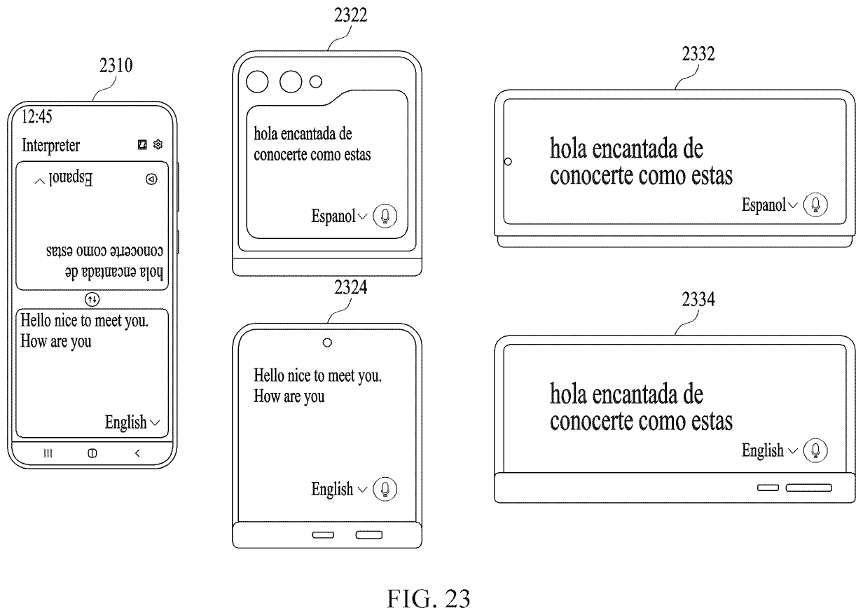

FIG. 23 is a diagram illustrating an example of outputting a translation result according to an embodiment of the disclosure.

Referring to FIG. 23, when wearable devices 2211, 2212, 2213, and 2214 of FIG. 22 are linked with the mobile devices 2221, 2222, and 2223, a translation result may be displayed on the screens of the linked mobile devices 2221, 2222, and 2223 instead of the wearable devices 2211, 2212, 2213, and 2214 with a small screen or without a screen. In this case, the linked mobile devices 2221, 2222, and 2223 may display the translation result according to the screen characteristics of the devices. For example, the bar-type smartphone 2221 may divide translation result areas of the user and partner up and down and may display the translation results separately and if necessary, may display one result upside down as the example of 2310.

In the case of foldable smartphones 2222 and 2223, as the examples of 2322 and 2332, a translation result of a user's voice may be output to the outer display, and as the examples of 2324 and 2334, a translation result of a partner's voice may be displayed on the inner display.

As described above, when the wearable devices 2211, 2212, 2213, and 2214 are linked with the mobile devices 2221, 2222, and 2223, the wearable devices 2211, 2212, 2213, and 2214 may receive the user's voice and when the gesture for requesting a translation is detected, the wearable devices 2211, 2212, 2213, and 2214 may display a translation result of the user's voice on a translation result area of the user of the mobile devices 2221, 2222, and 2223. In this case, the device for translating the input user's voice may be the wearable devices 2211, 2212, 2213, and 2214 or the mobile devices 2221, 2222, and 2223.

In addition, when the wearable devices 2211, 2212, 2213, and 2214 detect the gesture for requesting a translation while receiving a partner's voice, the wearable devices 2211, 2212, 2213, and 2214 may display a translation result of the partner's voice that is input until the gesture for requesting a translation is detected on a translation result area of the partner of the mobile devices 2221, 2222, and 2223. In this case, the device for translating the input partner's voice may be the wearable devices 2211, 2212, 2213, and 2214 or the mobile devices 2221, 2222, and 2223.

Accordingly, when the gesture for requesting a translation is detected even when the user or the partner is still speaking, the wearable devices 2211, 2212, 2213, and 2214 may translate the voice that is input until the gesture for requesting a translation is detected and may display the translation result.

FIG. 24 is a diagram illustrating an example of requesting a translation in a case of a smart ring according to an embodiment of the disclosure.

Referring to FIG. 24, a smart ring 2410 may set a gesture for requesting a translation to a double-tap gesture. In this case, the double-tap gesture may be performing a double-tap action by touching and then lifting two fingers (e.g., a thumb and an index finger) twice. The smart ring 2410 may detect the gesture by detecting a touch of two fingers and the number of touches through an inertial sensor included therein.

According to an embodiment, a method of translating using a gesture may include obtaining sensor data, determining a gesture of an electronic device and a state of the electronic device through the sensor data, when a gesture for requesting a translation is detected, identifying whether a screen direction of the electronic device is oriented to a user direction or a partner direction through the state of the electronic device, obtaining whether pre-obtained voice data exists, when the pre-obtained voice data exists, translating the pre-obtained voice data into a language of a user or a language of a partner based on the screen direction of the electronic device, and outputting translated text.

According to an embodiment, the gesture for requesting the translation may correspond to a gesture of VAD for identifying an end of an utterance.

According to an embodiment, the translating of the pre-obtained voice data into the language of the user or the language of the partner based on the screen direction of the electronic device when the pre-obtained voice data exists may include, when the pre-obtained voice data is a voice of the partner and the screen direction of the electronic device is oriented to the user direction, translating the pre-obtained voice data into the language of the user, and when the pre-obtained voice data is a voice of the user and the screen direction of the electronic device is oriented to the partner direction, translating the pre-obtained voice data into the language of the partner.

According to an embodiment, the method may further include, after the outputting of the translated text or when the pre-obtained voice data does not exist, obtaining the voice of the user or the voice of the partner based on the screen direction of the electronic device for a next translation.

According to an embodiment, the obtaining of the voice of the user or the voice of the partner based on the screen direction of the electronic device for the next translation may include, when the screen direction of the electronic device is oriented to the user direction, obtaining the voice of the user, and when the screen direction of the electronic device is oriented to the partner direction, obtaining the voice of the partner.

According to an embodiment, the obtaining of the voice of the user when the screen direction of the electronic device is oriented to the user direction may include converting the obtained voice of the user into text and displaying the converted text in a direction readable by the user.

According to an embodiment, the obtaining of the voice of the partner when the screen direction of the electronic device is oriented to the partner direction may include converting the obtained voice of the partner into text and displaying the converted text in a direction readable by the partner.

According to an embodiment, the outputting of the translated text may include, when the screen direction of the electronic device is oriented to the user direction, displaying translated text corresponding to the voice of the partner in the direction readable by the user, and when the screen direction of the electronic device is oriented to the partner direction, displaying translated text corresponding to the voice of the user in the direction readable by the partner.

According to an embodiment, the outputting of the translated text may include outputting the translated text by converting the translated text into an audio signal.

According to an embodiment, the gesture for requesting the translation may include at least one of a motion to change the screen direction of the electronic device to the user direction, a motion to change the screen direction of the electronic device to the partner direction, a motion to bring the electronic device closer to the partner, and a motion to bring the electronic device closer to the user.

According to an embodiment, the identifying of whether the screen direction of the electronic device is oriented to the user direction or the partner direction may include identifying whether a screen of the electronic device is tilted toward the user direction or the screen of the electronic device is tilted toward the partner direction as a result of determining the state of the electronic device.

According to an embodiment, the method may further include, before the translating, determining the language of the user and the language of the partner.

According to an embodiment, the determining of the language of the user may include at least one of determining a preset first language to be the language of the user, determining a language set to the electronic device to be the language of the user, determining a representative language of a region where the electronic device is located to be the language of the user, and determining a language obtained by analyzing the voice of the user that is initially input when a translation application is executed to be the language of the user.

According to an embodiment, the determining of the language of the partner may include at least one of determining a preset second language to be the language of the partner, determining a representative language of a region where the electronic device is located to be the language of the partner, and determining a language obtained by analyzing the voice of the partner that is initially input when a translation application is executed to be the language of the partner.

According to an embodiment, the outputting of the translated text may include, when the translated text is the voice of the partner, measuring a distance from the user and when the translated text is the voice of the user, measuring a distance from the partner, and adjusting a size of the translated text by considering the measured distance and displaying the adjusted translated text or adjusting a volume level of a converted audio signal corresponding to the translated text and outputting the converted audio signal.

According to an embodiment, the measuring of the distance from the user when the translated text is the voice of the partner and the measuring of the distance from the partner when the translated text is the voice of the user may include measuring the distance from the user or the distance from the partner using a distance measured by a distance detection sensor, measuring the distance from the user by TDoA using the voice of the user that is previously received through at least two microphones, or measuring the distance from the partner by TDoA using the voice of the partner that is previously received through the at least two microphones.

According to an embodiment, the electronic device may be a smartwatch.

A non-transitory computer-readable storage medium storing instructions that, when executed by a processor, cause the processor to obtain sensor data, determine a gesture of an electronic device and a state of the electronic device through the sensor data, when a gesture for requesting a translation is detected, identify whether a screen direction of the electronic device is oriented to a user direction or a partner direction through the state of the electronic device, obtain whether pre-obtained voice data exists, when the pre-obtained voice data exists, translate the pre-obtained voice data into a language of a user or a language of a partner based on the screen direction of the electronic device, and output translated text.

According to an embodiment, an electronic device may include an inertial sensor configured to measure inertial sensor data, one or more microphones configured to receive a voice, one or more processors, and memory configured to store instructions, wherein the instructions, when executed by the processor, cause the electronic device to obtain sensor data, determine a gesture of an electronic device and a state of the electronic device through the sensor data, when a gesture for requesting a translation is detected, identify whether a screen direction of the electronic device is oriented to a user direction or a partner direction through the state of the electronic device, obtain whether pre-obtained voice data exists, when the pre-obtained voice data exists, translate the pre-obtained voice data into a language of a user or a language of a partner based on the screen direction of the electronic device, and output translated text.

According to an embodiment, a method of translating using a gesture may include obtaining sensor data of a wearable device in the wearable device, determining a gesture of the wearable device and a state of the wearable device through the sensor data in the wearable device, when a gesture for requesting a translation is detected in the wearable device, identifying whether a screen direction of the wearable device is oriented to a user direction or a partner direction through the state of the wearable device, identifying whether pre-obtained voice data exists in the wearable device, when the pre-obtained voice data exists in the wearable device, transmitting the pre-obtained voice data to a mobile device to translate the pre-obtained voice data into a language of a user or a language of a partner based on the screen direction of the wearable device, translating the pre-obtained voice data transmitted from the wearable device into the language of the user or the language of the partner in the mobile device, and outputting translated text in the mobile device.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of translating using a gesture, the method comprising:
obtaining sensor data;
determining a gesture of an electronic device and a state of the electronic device through the sensor data;
when a gesture for requesting a translation is detected, identifying whether a screen direction of the electronic device is oriented to a user direction or a partner direction through the state of the electronic device;
obtaining whether pre-obtained voice data exists;
when the pre-obtained voice data exists, translating the pre-obtained voice data into a language of a user or a language of a partner based on the screen direction of the electronic device; and
outputting translated text.

2. The method of claim 1, wherein the gesture for requesting the translation corresponds to a gesture of voice activity detection (VAD) for identifying an end of an utterance.

3. The method of claim 1, wherein the translating of the pre-obtained voice data into the language of the user or the language of the partner based on the screen direction of the electronic device when the pre-obtained voice data exists comprises:
when the pre-obtained voice data is a voice of the partner and the screen direction of the electronic device is oriented to the user direction, translating the pre-obtained voice data into the language of the user; and
when the pre-obtained voice data is a voice of the user and the screen direction of the electronic device is oriented to the partner direction, translating the pre-obtained voice data into the language of the partner.

4. The method of claim 1, further comprising:
after the outputting of the translated text or when the pre-obtained voice data does not exist, obtaining the voice of the user or the voice of the partner based on the screen direction of the electronic device for a next translation.

5. The method of claim 1, wherein the obtaining of the voice of the user or the voice of the partner based on the screen direction of the electronic device for a next translation comprises:
when the screen direction of the electronic device is oriented to the user direction, obtaining the voice of the user; and
when the screen direction of the electronic device is oriented to the partner direction, obtaining the voice of the partner.

6. The method of claim 1, wherein the obtaining of the voice of the user when the screen direction of the electronic device is oriented to the user direction comprises:
converting the obtained voice of the user into text and displaying the converted text in a direction readable by the user.

7. The method of claim 1, wherein the obtaining of the voice of the partner when the screen direction of the electronic device is oriented to the partner direction comprises:
converting the obtained voice of the partner into text and displaying the converted text in a direction readable by the partner.

8. The method of claim 1, wherein the outputting of the translated text comprises:
when the screen direction of the electronic device is oriented to the user direction, displaying translated text corresponding to the voice of the partner in the direction readable by the user; and
when the screen direction of the electronic device is oriented to the partner direction, displaying translated text corresponding to the voice of the user in the direction readable by the partner.

9. The method of claim 1, wherein the outputting of the translated text comprises:
outputting the translated text by converting the translated text into an audio signal.

10. The method of claim 1, wherein the gesture for requesting the translation comprises at least one of:
a motion to change the screen direction of the electronic device to the user direction;
a motion to change the screen direction of the electronic device to the partner direction;
a motion to bring the electronic device closer to the partner; or a motion to bring the electronic device closer to the user.

11. The method of claim 1, wherein the identifying of whether the screen direction of the electronic device is oriented to the user direction or the partner direction comprises:
identifying whether a screen of the electronic device is tilted toward the user direction or the screen of the electronic device is tilted toward the partner direction as a result of determining the state of the electronic device.

12. The method of claim 1, further comprising:
before the translating, determining the language of the user and the language of the partner.

13. The method of claim 12, wherein the determining of the language of the user comprises at least one of:
determining a preset first language to be the language of the user;
determining a language set to the electronic device to be the language of the user;
determining a representative language of a region where the electronic device is located to be the language of the user; or
determining a language obtained by analyzing the voice of the user that is initially input when a translation application is executed to be the language of the user, and/or
wherein the determining of the language of the partner comprises at least one of:
determining a preset second language to be the language of the partner;
determining a representative language of a region where the electronic device is located to be the language of the partner; or
determining a language obtained by analyzing the voice of the partner that is initially input when a translation application is executed to be the language of the partner.

14. The method of claim 1, wherein the outputting of the translated text comprises:
when the translated text is the voice of the partner, measuring a distance from the user and when the translated text is the voice of the user, measuring a distance from the partner; and
adjusting a size of the translated text by considering the measured distance and displaying the adjusted translated text or adjusting a volume level of a converted audio signal corresponding to the translated text and outputting the converted audio signal.

15. The method of claim 14, wherein the measuring of the distance from the user when the translated text is the voice of the partner and the measuring of the distance from the partner when the translated text is the voice of the user comprises:
measuring the distance from the user or the distance from the partner using a distance measured by a distance detection sensor;
measuring the distance from the user by time difference of arrival (TDoA) using the voice of the user that is previously received through at least two microphones; or
measuring the distance from the partner by TDoA using the voice of the partner that is previously received through the at least two microphones.

16. The method of claim 15, wherein adjusting the size of the translated text by considering the measured distance and displaying the adjusted translated text comprises increasing a font size of translated content when the measured distance is greater than a first threshold.

17. The method of claim 16, wherein the method further comprises when the electronic device is unable to output the adjusted translated content with an increased font size to a screen of the electronic device or when the user configures the electronic device to output summarized content:
summarizing the translated content, and
displaying the summarization of the translated content.

18. The method of claim 1, wherein the electronic device is a smartwatch.

19. An electronic device comprising:
an inertial sensor configured to measure inertial sensor data;
one or more microphones configured to receive a voice;
memory storing one or more computer programs; and
one or more processors communicatively coupled to the inertial sensor, the one or more microphones, and the memory, wherein the one or more computer programs include computer-executable instructions that, when executed by the one or more processors individually or collectively, cause the electronic device to:
obtain sensor data,
determine a gesture of an electronic device and a state of the electronic device through the sensor data,
when a gesture for requesting a translation is detected, identify whether a screen direction of the electronic device is oriented to a user direction or a partner direction through the state of the electronic device,
obtain whether pre-obtained voice data exists,
when the pre-obtained voice data exists, translate the pre-obtained voice data into a language of a user or a language of a partner based on the screen direction of the electronic device, and
output translated text.

20. One or more non-transitory computer-readable storage media storing one or more computer programs including computer-executable instructions that, when executed by one or more processors of an electronic device individually or collectively, cause the electronic device to perform operations, the operations comprising:
obtaining sensor data;
determining a gesture of an electronic device and a state of the electronic device through the sensor data;
when a gesture for requesting a translation is detected, identifying whether a screen direction of the electronic device is oriented to a user direction or a partner direction through the state of the electronic device;
obtaining whether pre-obtained voice data exists;
when the pre-obtained voice data exists, translating the pre-obtained voice data into a language of a user or a language of a partner based on the screen direction of the electronic device; and
outputting translated text.
